(19) United States
(12) Patent Application Publication
(10) Pub. No.: US 2023/0067276 A1
(43) Pub. Date: Mar. 2, 2023

(54) SHOCK ABSORBER

(71) Applicant: DRiV Automotive Inc., Lake Forest, IL (US)

(72) Inventor: Joseph Casper Bacarella, La Salle, MI (US)

(21) Appl. No.: 17/461,265

(22) Filed: Aug. 30, 2021

(51) Int. Cl. B60G 15/06

(52) U.S. Cl. CPC B60G 15/067; B60G 2202/24; B60G 2202/32

(57) ABSTRACT

A shock absorber for a vehicle includes a damper tube defining a valving piston chamber that contains a hydraulic fluid. The shock absorber further includes a piston rod extending within the damper tube along a first longitudinal axis, and a valving piston assembly slidably fitted in the damper tube. The shock absorber further includes a seat tube disposed in fluid communication with the valving piston chamber and defining a seat piston chamber therein. The shock absorber further includes a seat piston slidably fitted at least partially in the seat tube. The seat piston is configured to move along a second longitudinal axis relative to the seat tube based on a pressure of the hydraulic fluid within the seat tube.

### TECHNICAL FIELD

The present disclosure relates to a shock absorber for a vehicle, and more particularly, to a height responsive shock absorber and an anti-bottoming shock absorber for a vehicle.

### BACKGROUND

Suspension systems are provided to filter or isolate the vehicle's body (sprung portion) from the vehicle's wheels and axles (unsprung portion) when the vehicle travels over vertical road surface irregularities as well as to control body and wheel motion. In addition, suspension systems are also used to maintain an average vehicle attitude to promote improved stability of the vehicle during maneuvering. The typical passive suspension system includes a spring and a shock absorber in parallel with the spring which are located between the sprung portion and the unsprung portion of the vehicle. Shock absorbers are typically used in conjunction with automotive suspension systems or other suspension systems to absorb unwanted vibrations that occur during movement of the suspension system.

In typical shock absorbers, a piston is located within a fluid chamber defined by a damper tube and is connected to the sprung mass of the vehicle through a piston rod. The damper tube is connected to the unsprung mass of the vehicle. The piston divides the fluid chamber of the damper tube into an upper working chamber and a lower working chamber. The piston includes a compression valving that limits the flow of a hydraulic fluid from the lower working chamber to the upper working chamber during a compression stroke. The piston also includes a rebound valving that limits the flow of the hydraulic fluid from the upper working chamber to the lower working chamber during a rebound or an extension stroke. By controlling the fluid flow between the upper working chamber and the lower working chamber, a pressure drop is built up between the upper working chamber and the lower working chamber. As each of the compression valving and the rebound valving has an ability to limit the flow of the hydraulic fluid, the shock absorber is able to produce damping forces that counteract oscillations/vibrations, which would otherwise be transmitted from the unsprung mass to the sprung mass.

In recent years, there is growing consumer interest in affordable, yet advanced, vehicle suspension dynamics. Nowadays, a substantial interest has grown in automotive vehicle suspension systems which can offer improved comfort and road handling over the conventional passive suspension systems. Further, some of the conventional suspension systems use an external power device (e.g., a pump) to get an overall improved ride comfort and vehicle dynamics. However, use of external power devices may increase a weight and a cost of the suspension systems.

The conventional passive suspension systems may offer an ordinary handling characteristics, stability, and control. More particularly, in some cases, the conventional suspension systems may not maintain an acceptable ride height under various loading conditions. There is a need for a suspension system and/or a shock absorber which can consistently respond to ride height changes, and to suspension movements. Further, there is a need for a suspension system and/or a shock absorber with significant improvements in vehicle ride comfort, stability, and control.

### SUMMARY

According to a first aspect, there is provided a shock absorber for use with a sprung portion and an unsprung portion of a vehicle. The shock absorber includes a damper tube defining a valving piston chamber containing a hydraulic fluid. The shock absorber further includes a piston rod extending within the damper tube along a first longitudinal axis. The shock absorber further includes a valving piston assembly slidably fitted in the damper tube for movement along the first longitudinal axis relative to the damper tube. The valving piston assembly is coupled to the piston rod. The shock absorber further includes a seat tube disposed in fluid communication with the valving piston chamber and configured to receive the hydraulic fluid from the valving piston chamber. The seat tube defines a seat piston chamber therein. The shock absorber further includes a seat piston slidably fitted at least partially in the seat tube for movement along a second longitudinal axis relative to the seat tube. The seat piston is configured to move along the second longitudinal axis based on a pressure of the hydraulic fluid within the seat tube. The shock absorber further includes a first spring seat fixedly coupled to the seat piston for movement with the seat piston along the second longitudinal axis. The shock absorber further includes a second spring seat spaced apart from the first spring seat. The second spring seat is fixedly coupled to one of the piston rod, the damper tube, and the sprung portion of the vehicle. The shock absorber further includes a spring engaged with the first spring seat and the second spring seat. The spring is configured to compress or extend based on a relative movement between the first spring seat and the second spring seat.

According to a second aspect, there is provided a shock absorber for use with a sprung portion and an unsprung portion of a vehicle. The shock absorber includes a damper tube defining a valving piston chamber containing a hydraulic fluid. The shock absorber further includes a piston rod extending within the damper tube along a first longitudinal axis. The shock absorber further includes a valving piston assembly slidably fitted in the damper tube for movement along the first longitudinal axis relative to the damper tube. The valving piston assembly is coupled to the piston rod. The shock absorber further includes a seat tube disposed in fluid communication with the valving piston chamber and configured to receive the hydraulic fluid from the valving piston chamber. The seat tube defines a seat piston chamber therein. The shock absorber further includes a seat piston slidably fitted at least partially in the seat tube for movement along a second longitudinal axis relative to the seat tube. The seat piston is configured to move along the second longitudinal axis based on a pressure of the hydraulic fluid within the seat tube. The shock absorber further includes a bumper seat fixedly coupled to the seat piston for movement with the seat piston along the second longitudinal axis. The shock absorber further includes a jounce bumper fixedly coupled to one of the piston rod and the bumper seat.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF DRAWINGS

FIG. 1 is an illustration of a vehicle, according to an embodiment of the present disclosure;

FIG. 2A is a side cross-sectional view of a shock absorber of the vehicle of FIG. 1, where the shock absorber is shown in a static position, according to an embodiment of the present disclosure;

FIG. 2B is a side cross-sectional view of the shock absorber of FIG. 2A, where the shock absorber is shown in a compressed position, according to an embodiment of the present disclosure;

FIG. 2C is a side cross-sectional view of the shock absorber of FIG. 2A, where the shock absorber is shown in an extended position, according to an embodiment of the present disclosure;

FIG. 3 is a side cross-sectional view of a shock absorber of the vehicle of FIG. 1, according to another embodiment of the present disclosure;

FIG. 4A is a side cross-sectional view of a shock absorber of the vehicle of FIG. 1, according to another embodiment of the present disclosure;

FIG. 4B is a side cross-sectional view of a shock absorber of the vehicle of FIG. 1, according to another embodiment of the present disclosure;

FIG. 5A is a side cross-sectional view of a shock absorber of the vehicle of FIG. 1, according to another embodiment of the present disclosure;

FIG. 5B is a side cross-sectional view of a shock absorber of the vehicle of FIG. 1, according to another embodiment of the present disclosure;

FIG. 6 is a side cross-sectional view of a shock absorber of the vehicle of FIG. 1, according to another embodiment of the present disclosure;

FIG. 7A is a side cross-sectional view of a shock absorber of the vehicle of FIG. 1, according to another embodiment of the present disclosure;

FIG. 7B is a side cross-sectional view of a shock absorber of the vehicle of FIG. 1, according to another embodiment of the present disclosure;

FIG. 7C is a side cross-sectional view of a shock absorber of the vehicle of FIG. 1, according to another embodiment of the present disclosure;

FIG. 8A is a side cross-sectional view of a shock absorber of the vehicle of FIG. 1, according to another embodiment of the present disclosure;

FIG. 8B is a side cross-sectional view of a shock absorber of the vehicle of FIG. 1, according to another embodiment of the present disclosure;

FIG. 8C is a side cross-sectional view of a shock absorber of the vehicle of FIG. 1, according to another embodiment of the present disclosure;

FIG. 9A is a side cross-sectional view of a shock absorber of the vehicle of FIG. 1, according to another embodiment of the present disclosure;

FIG. 9B is a side cross-sectional view of a shock absorber of the vehicle of FIG. 1, according to another embodiment of the present disclosure;

FIG. 10A is a side cross-sectional view of a shock absorber of the vehicle of FIG. 1, according to another embodiment of the present disclosure;

FIG. 10B is a side cross-sectional view of a shock absorber of the vehicle of FIG. 1, according to another embodiment of the present disclosure;

FIG. 11A is a side cross-sectional view of a shock absorber of the vehicle of FIG. 1, according to another embodiment of the present disclosure;

FIG. 11B is a side cross-sectional view of the shock absorber of FIG. 11A, where the shock absorber is shown in a compressed position, according to an embodiment of the present disclosure;

FIG. 12 is a side cross-sectional view of a shock absorber of the vehicle of FIG. 1, according to another embodiment of the present disclosure;

FIG. 13A is a side cross-sectional view of a shock absorber of the vehicle of FIG. 1, according to another embodiment of the present disclosure;

FIG. 13B is a side cross-sectional view of a shock absorber of the vehicle of FIG. 1, according to another embodiment of the present disclosure;

FIG. 14 is a side cross-sectional view of a shock absorber of the vehicle of FIG. 1, according to another embodiment of the present disclosure;

FIG. 15A is a side cross-sectional view of a shock absorber of the vehicle of FIG. 1, according to another embodiment of the present disclosure;

FIG. 15B is a side cross-sectional view of a shock absorber of the vehicle of FIG. 1, according to another embodiment of the present disclosure;

FIG. 15C is a side cross-sectional view of a shock absorber of the vehicle of FIG. 1, according to another embodiment of the present disclosure;

FIG. 16A is a side cross-sectional view of a shock absorber of the vehicle of FIG. 1, according to another embodiment of the present disclosure;

FIG. 16B is a side cross-sectional view of a shock absorber of the vehicle of FIG. 1, according to another embodiment of the present disclosure; and

FIG. 16C is a side cross-sectional view of a shock absorber of the vehicle of FIG. 1, according to another embodiment of the present disclosure;

### DETAILED DESCRIPTION

The following description of the preferred embodiment(s) is merely exemplary in nature and is in no way intended to limit the invention, its application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the statement that two or more parts or components are “coupled” shall mean that the parts are joined or operate together either directly or indirectly, i.e., through one or more intermediate parts or components, so long as a link occurs. As used herein, “fixedly connected” or “fixed” means that two components are coupled so as to move as one while maintaining a constant orientation relative to each other.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Referring now to the drawings in which like reference numerals designate like or corresponding parts throughout the several views.

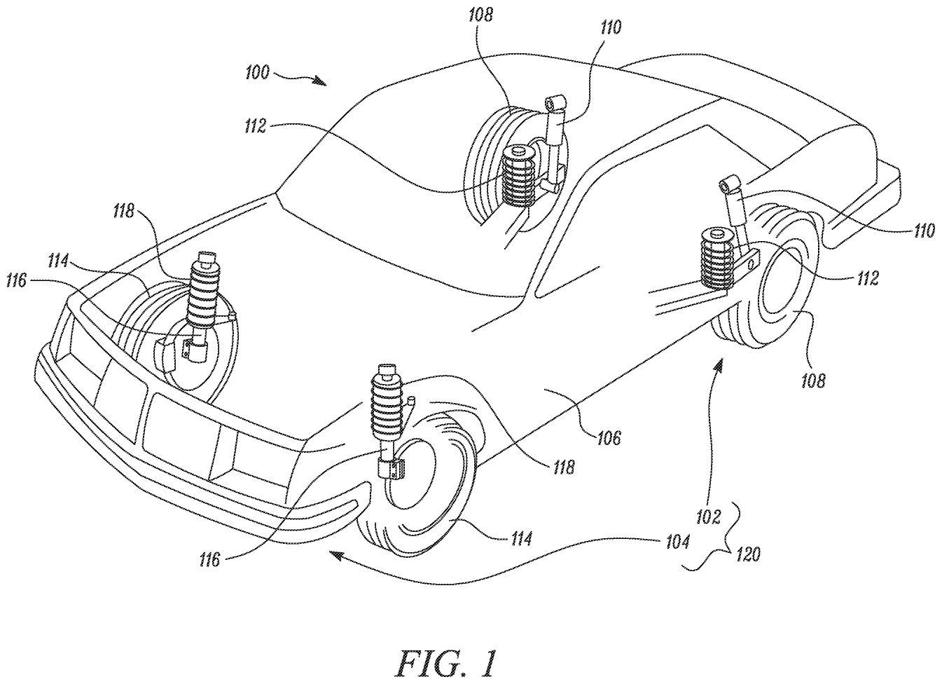

FIG. 1 illustrates a vehicle 100 according to an embodiment of the present disclosure. The vehicle 100 includes a rear suspension 102, a front suspension 104, and a body 106. The rear suspension 102 has a transversely extending rear axle assembly (not shown) adapted to operatively support the vehicle's rear wheels 108. The rear axle assembly is operatively connected to the body 106 by a pair of shock absorbers 110. Each of the shock absorbers 110 includes a spring 112. Similarly, the front suspension 104 includes a transversely extending front axle assembly (not shown) to operatively support the vehicle's front wheels 114. The front axle assembly is operatively connected to the body 106 by another pair of shock absorbers 116. Each of the shock absorbers 116 includes a spring 118. The front suspension 104 and the rear suspension 102 together form an unsprung portion 120 of the vehicle 100. Further, in some embodiments, the body 106 of the vehicle 100 is interchangeably referred to herein as a sprung portion 106 of the vehicle 100.

The shock absorbers 110, 116 serve to dampen a relative motion between the unsprung portion 120 and the sprung portion 106 of the vehicle 100. While the vehicle 100 has been depicted as a passenger car having front and rear axle assemblies, the shock absorbers 110, 116 may be used with other types of vehicles or machinery, or in other types of applications such as vehicles incorporating independent front and/or independent rear suspension systems. Further, the term “shock absorber” as used herein is meant to refer to shock absorbers and shock absorber systems in general and thus may include MacPherson struts, and semi-active and active shock absorbers. It should also be appreciated that the scope of the subject disclosure is intended to include shock absorber systems for stand-alone shock absorbers 110 and coil-over shock absorbers 116.

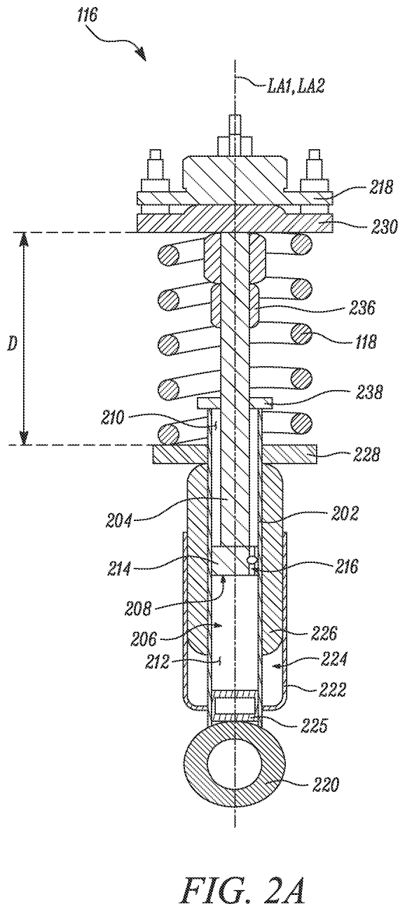

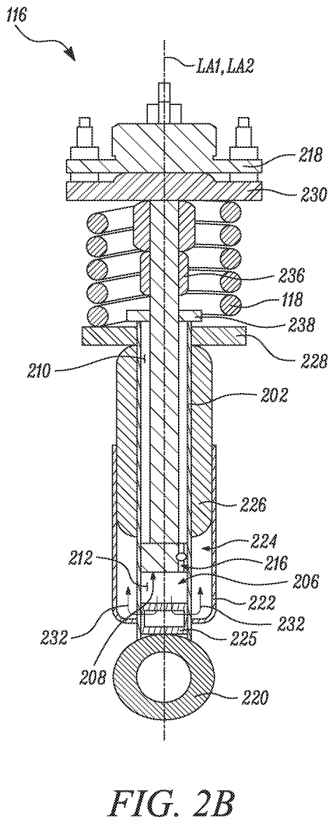

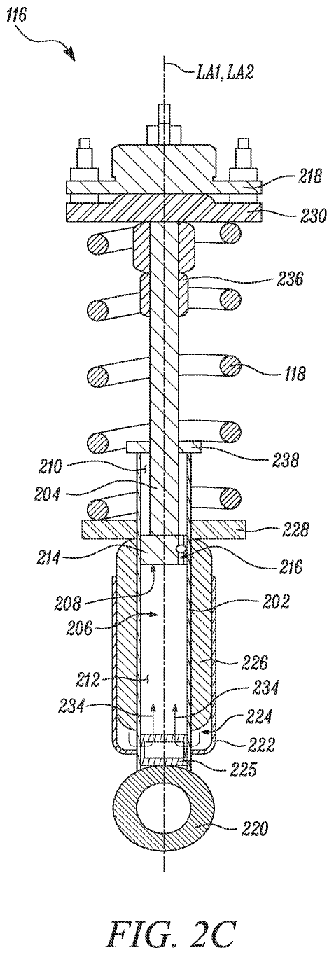

FIG. 2A illustrates the shock absorber 116 for use with the sprung portion 106 and the unsprung portion 120 of the vehicle 100 (shown in FIG. 1), according to an embodiment of the present disclosure. The shock absorber 116 includes a damper tube 202 defining a valving piston chamber 206 containing a hydraulic fluid. The shock absorber 116 includes a piston rod 204 extending within the damper tube 202 along a first longitudinal axis LA1. The piston rod 204 reciprocates along the first longitudinal axis LA1. Thus, the damper tube 202 and the piston rod 204 extend co-axially along the first longitudinal axis LA1. With reference to FIG. 2A, the shock absorber 116 is shown in a static or an intermediate position.

The shock absorber 116 further includes a valving piston assembly 208 slidably fitted in the damper tube 202 for movement along the first longitudinal axis LA1 relative to the damper tube 202. The valving piston assembly 208 is coupled to the piston rod 204 and separates the valving piston chamber 206 into an upper working chamber 210 and a lower working chamber 212. The shock absorber 116 may include a seal (not shown) disposed between the valving piston assembly 208 and the damper tube 202 to permit sliding movement of the valving piston assembly 208 with respect to the damper tube 202 without generating undue frictional forces as well as sealing the upper working chamber 210 from the lower working chamber 212.

The valving piston assembly 208 includes a valving piston 214 attached to the piston rod 204. The valving piston assembly 208 further includes a valve assembly 216 that controls fluid flow between the upper working chamber 210 and the lower working chamber 212. Specifically, the valve assembly 216 controls the movement of hydraulic fluid between the upper working chamber 210 and the lower working chamber 212 during movement of the valving piston assembly 208 within the damper tube 202. Further, the valve assembly 216 may include at least one compression valve, at least one rebound valve, and at least one bleed valve, which are not shown in FIG. 2A for the purposes of clarity.

Referring to FIGS. 1 and 2A, the shock absorber 116 further includes a first mount 218 coupled to the sprung portion 106 of the vehicle 100 and a second mount 220 coupled to the unsprung portion 120 of the vehicle 100. The damper tube 202 and the piston rod 204 extend between the first and second mounts 218, 220. In some embodiments, the piston rod 204 is coupled to one of the first mount 218 and the second mount 220, and the damper tube 202 is coupled to the other one of the first mount 218 and the second mount 220. In the illustrated embodiment of FIG. 2A, the piston rod 204 is coupled to the first mount 218 and the damper tube 202 is coupled to the second mount 220. In some other embodiments, the piston rod 204 may be coupled to the second mount 220 and the damper tube 202 may be coupled to the first mount 218.

The shock absorber 116 further includes a seat tube 222 disposed in fluid communication with the valving piston chamber 206 and configured to receive the hydraulic fluid from the valving piston chamber 206. In the illustrated embodiment of FIG. 2A, the seat tube 222 is disposed in fluid communication with the lower working chamber 212 and configured to receive the hydraulic fluid from the lower working chamber 212. In the illustrated embodiment of FIG. 2A, the seat tube 222 is disposed in direct fluid communication with the valving piston chamber 206. In some other embodiments, the seat tube 222 may be disposed in indirect fluid communication with the valving piston chamber 206. The seat tube 222 defines a seat piston chamber 224 therein. In the illustrated embodiment of FIG. 2A, the seat tube 222 is at least partially disposed around and fixedly coupled to the damper tube 202.

With reference to FIG. 2A, in some embodiments, the shock absorber 116 includes a base valve 225 fluidly disposed between the valving piston chamber 206 and the seat piston chamber 224. Specifically, the base valve 225 is fluidly disposed between the lower working chamber 212 and the seat piston chamber 224. The base valve 225 is configured to control fluid flow between the valving piston chamber 206 and the seat piston chamber 224. The base valve 225 is disposed proximal to the second mount 220 and distal to the first mount 218. During a compression stroke of the shock absorber 116, the base valve 225 controls fluid flow from the lower working chamber 212 to the seat piston chamber 224. During an extension stroke of the shock absorber 116, the base valve 225 controls fluid flow from the seat piston chamber 224 to the lower working chamber 212.

The shock absorber 116 further includes a seat piston 226 slidably fitted at least partially in the seat tube 222 for movement along a second longitudinal axis LA2 relative to the seat tube 222. In some embodiments, the second longitudinal axis LA2 is substantially aligned with or parallelly offset from the first longitudinal axis LA1. In the illustrated embodiment of FIG. 2A, the second longitudinal axis LA2 is substantially aligned with the first longitudinal axis LA1.

The seat piston 226 is configured to move along the second longitudinal axis LA2 based on a pressure of the hydraulic fluid within the seat tube 222. In other words, the seat piston 226 is configured to move along the second longitudinal axis LA2 based on a pressure of the hydraulic fluid in the seat piston chamber 224.

The shock absorber 116 further includes a first spring seat 228 fixedly coupled to the seat piston 226 for movement with the seat piston 226 along the second longitudinal axis LA2. In the illustrated embodiment of FIG. 2A, the first spring seat 228 is directly coupled to the seat piston 226. In some other embodiments, the first spring seat 228 may be indirectly coupled to the seat piston 226. Therefore, when the seat piston 226 moves along the second longitudinal axis LA2 based on a pressure of the hydraulic fluid in the seat piston chamber 224, the first spring seat 228 also moves along the second longitudinal axis LA2. In the illustrated embodiment of FIG. 2A, each of the seat piston 226 and the first spring seat 228 is slidably mounted around the damper tube 202.

The shock absorber 116 further includes a second spring seat 230 spaced apart from the first spring seat 228. The second spring seat 230 is fixedly coupled to one of the piston rod 204, the damper tube 202, and the sprung portion 106 of the vehicle 100. In the illustrated embodiment of FIG. 2A, the second spring seat 230 is fixedly coupled to the piston rod 204 proximal to the first mount 218.

The shock absorber 116 further includes the spring 118 engaged with the first spring seat 228 and the second spring seat 230. The spring 118 extends between the first spring seat 228 and the second spring seat 230. The spring 118 is configured to compress or extend based on a relative movement between the first spring seat 228 and the second spring seat 230. In a compression stroke of the shock absorber 116, the relative movement of the first spring seat 228 and the second spring seat 230 is towards each other and hence, the spring 118 is compressed. In an extension stroke of the shock absorber 116, the relative movement of the first spring seat 228 and the second spring seat 230 is away from each other and hence, the spring 118 is extended. In some embodiments, the spring 118 is a helical coil spring.

The shock absorber 116 further includes a jounce bumper 236 mounted around the piston rod 204 and spaced apart from the damper tube 202. The jounce bumper 236 is typically configured to prevent bottoming out (i.e., rigid metal on metal contact) of the sprung portion 106 of the vehicle 100. The jounce bumper 236 is designed to minimize noise and improve ride comfort. In some cases, the jounce bumper 236 may be formed of a resilient material, such as rubber, closed cell foam, or a resilient polymer.

The jounce bumper 236 is configured to contact a surface of a striker member 238 during the compression stroke of the shock absorber 116. The striker member 238 is disposed at top of the damper tube 202, though other configurations can also be used. In some cases, the jounce bumper 236 may be disposed around the piston rod 204 proximate to where the piston rod 204 enters the damper tube 202 and may be fixedly coupled to the damper tube 202. In some other cases, the jounce bumper 236 can be disposed around the piston rod 204 and free to move along the piston rod 204 relative to the damper tube 202, while the striker member 238 can be fixedly coupled to the first mount 218.

It should be noted that various components of the shock absorber 116 are shown schematically in FIG. 2A for the purposes of clarity. For example, the valve assembly 216 and the base valve 225 are shown schematically in FIG. 2A and at least some of their individual parts are omitted herein for clarity.

FIG. 2B illustrates the shock absorber 116 in a compressed position, according to an embodiment of the present disclosure. During the compression stroke of the shock absorber 116, fluid pressure builds up in the lower working chamber 212 of the valving piston chamber 206. Due to this pressure build up, some of the hydraulic fluid in the lower working chamber 212 flows out into the seat piston chamber 224 through the base valve 225. Movement of hydraulic fluid from the lower working chamber 212 to the seat piston chamber 224 of the seat tube 222 is shown by a flow path 232. This fluid movement increases the pressure of the hydraulic fluid within the seat tube 222. The increased fluid pressure within the seat tube 222 causes the seat piston 226 to move towards the second spring seat 230 along the second longitudinal axis LA2. As the first spring seat 228 is fixedly coupled to the seat piston 226, the first spring seat 228 is also moved towards the second spring seat 230 along the second longitudinal axis LA2 upon movement of the seat piston 226 towards the second spring seat 230.

Further, during the compression stroke of the shock absorber 116, the piston rod 204 travels towards the second mount 220 and therefore, the second spring seat 230 is moved towards the first spring seat 228. Movement of the first spring seat 228 and the second spring seat 230 towards each other results in compression of the spring 118. In other words, relative movement of the first spring seat 228 and the second spring seat 230 towards each other causes the spring 118 to compress.

Therefore, during the compression stroke of the shock absorber 116, for a given movement of the piston rod 204, a distance D (shown in FIG. 2A) between the first spring seat 228 and the second spring seat 230 is decreased by a greater degree as compared to conventional shock absorbers. In other words, the shock absorber 116 may have an increased ratio of spring compression to piston rod movement than conventional shock absorbers. With an increased ratio of spring compression to piston rod movement, the shock absorber 116 may use the spring 118 with a lighter spring rate. Due to lighter spring rate of the spring 118, an effective spring load is exponentially increased as the shock absorber 116 approaches a fully compressed position (not shown). In other words, a lighter spring rate of the spring 118 is exponentially increased (i.e., effective spring rate is exponentially increased) due to induced relative movement of the first spring seat 228 and the second spring seat 230 towards each other during the compression stroke of the shock absorber 116.

An exponential increment in the spring rate of the spring 118 during the compression stroke may enable the shock absorber 116 to offer an increased ride comfort. For example, in conventional suspension systems, when a piston rod moves 3″ (measured at a valving piston assembly) in the compression stroke, a spring is also compressed 3″. However, in the shock absorber 116, when the piston rod 204 moves 3″ (measured at the valving piston assembly 208), the spring 118 is compressed more than 3″ due to additional distance travelled by the first spring seat 228 caused by fluid pressure build up within the seat tube 222. In an example, when the piston rod 204 moves 3″ in the compression stroke, the spring 118 may be compressed to 4″ to 5″. This may effectively increase the load rating of the spring 118 during the compression stroke. Further, the increased load rating of the spring 118 may reduce a tendency of the front and rear suspensions 104, 102 to bottom out, lean or sway, dive or squat. Therefore, the shock absorber 116 with the seat piston 226 and the seat tube 222 may significantly improve a ride quality, a steering response, and an overall stability of the vehicle 100.

FIG. 2C illustrates the shock absorber 116 in an extended position, according to an embodiment of the present disclosure. During an extension stroke of the shock absorber 116, fluid pressure is released in the lower working chamber 212 of the valving piston chamber 206. Due to this release in fluid pressure, some of the hydraulic fluid in the seat piston chamber 224 flows out into the lower working chamber 212 through the base valve 225. Movement of hydraulic fluid from the seat piston chamber 224 of the seat tube 222 to the lower working chamber 212 of the valving piston chamber 206 is shown by a flow path 234. This fluid movement reduces the pressure of the hydraulic fluid within the seat tube 222. The reduced fluid pressure within the seat tube 222 causes the seat piston 226 to move away from the second spring seat 230 along the second longitudinal axis LA2. As the first spring seat 228 is fixedly coupled to the seat piston 226, the first spring seat 228 is also moved away from the second spring seat 230 along the second longitudinal axis LA2 upon movement of the seat piston 226 away from the second spring seat 230.

Further, during the extension stroke of the shock absorber 116, the piston rod 204 travels towards the first mount 218 and therefore, the second spring seat 230 is moved away from the first spring seat 228. Movement of the first spring seat 228 and the second spring seat 230 away from each other results in extension of the spring 118. In other words, relative movement of the first spring seat 228 and the second spring seat 230 away from each other causes the spring 118 to extend.

Therefore, during the extension stroke of the shock absorber 116, for a given movement of the piston rod 204, the distance D (shown in FIG. 2A) between the first spring seat 228 and the second spring seat 230 is increased by a greater degree as compared to conventional shock absorbers. In other words, the shock absorber 116 may have an increased ratio of spring extension to piston rod movement as compared to conventional shock absorbers. With an increased ratio of spring extension to piston rod movement, the shock absorber 116 may use the spring 118 with a lighter spring rate. Due to lighter spring rate of the spring 118, an effective spring load is exponentially reduced as the shock absorber 116 approaches a fully extended position (not shown). In other words, a lighter spring rate of the spring 118 is exponentially reduced (i.e., the effective spring rate is exponentially reduced) due to induced relative movement of the first spring seat 228 and the second spring seat 230 away from each other during the extension stroke of the shock absorber 116.

An exponential reduction in the spring rate of the spring 118 during the extension stroke may enable the shock absorber 116 to offer an increased ride comfort. For example, in conventional suspension systems, when a piston rod moves 3″ (measured at a valving piston assembly) in the extension stroke, a spring is also extended 3″. However, in the shock absorber 116, when the piston rod 204 moves 3″ (measured at the valving piston assembly 208), the spring 118 is extended more than 3″ due to additional distance travelled by the first spring seat 228 caused by release of fluid pressure within the seat tube 222. In an example, when the piston rod 204 moves 3″ in the extension stroke, the spring 118 may be extended 4″ to 5″. This may effectively reduce the load rating of the spring 118 during the extension stroke. Further, the reduced load rating of the spring 118 may reduce a tendency of the front and rear suspensions 104, 102 to top out, lean or sway, dive or squat. Therefore, the shock absorber 116 with the seat piston 226 and the seat tube 222 may significantly improve a ride quality, a steering response, and an overall stability of the vehicle 100.

Referring to FIGS. 1, 2A, 2B, and 2C, during both the compression and extension strokes, the distance D between the first spring seat 228 and the second spring seat 230 is dynamically adjusted based on movement of the piston rod 204, so that the vehicle 100 with the shock absorber 116 may experience less variance in ride height during suspension movements. Therefore, the shock absorber 116 is a height responsive shock absorber. When the vehicle 100 including the shock absorber 116 is used for applications intended for towing, or varying cabin loads, the ride height of the vehicle 100 may squat less and not require a higher ground clearance. Therefore, the shock absorber 116 works to maintain ride height with or without an external control system, an electrohydraulic servo valve, or an actuator (e.g., a pump).

Further, due to dynamic spring rate of the spring 118 in the compression and extension strokes, there may be a reduced lean and sway associated with the front and rear suspensions 104, 102. The reduced sway in the vehicle 100 by using the shock absorber 116 may allow a manufacturer to reduce a diameter of anti-sway bars, which may further improve the ride comfort. In some cases, the shock absorber 116 may even allow elimination of the anti-sway bars in the vehicle 100. This may reduce a weight of the vehicle 100 and further contribute to improved fuel economy and performance, while reducing emissions. Moreover, reduction in diameter of the anti-sway bars may also reduce a cost of a suspension system of a vehicle.

Since the dynamic spring rate of the spring 118 and dynamic adjustment of the distance D between the first spring seat 228 and the second spring seat 230 are hydraulically linked to piston rod movement, the shock absorber 116 may be economically incorporated to new or existing applications without the requirement of complex and expensive external control systems. Thus, in high end applications, the shock absorber 116 may simulate advantages and benefits of much more complex and expensive active and semi active shock absorbers.

Referring to FIGS. 2A, 2B, and 2C, when the shock absorber 116 is compressed or extended, fluid within the damper tube 202 is displaced by the piston rod 204, such that the fluid pressure in the seat piston chamber 224 is varied to adjust the distance between the first spring seat 228 and the second spring seat 230. With the dynamic adjustment of the distance D between the first spring seat 228 and the second spring seat 230 based on the fluid pressure in the seat piston chamber 224, the effective spring rate of the spring 118 is exponentially increased or decreased depending on the type of stroke. The fluid pressure in the seat piston chamber 224, a lifting force associated with the seat piston 226, and the distance D between the first spring seat 228 and the second spring seat 230 may be based on a ratio of displacement of the piston rod 204 to a hydraulic surface area of the seat piston 226. Therefore, various sizes of the piston rod 204 and the seat piston 226 may be chosen as per desired application attributes.

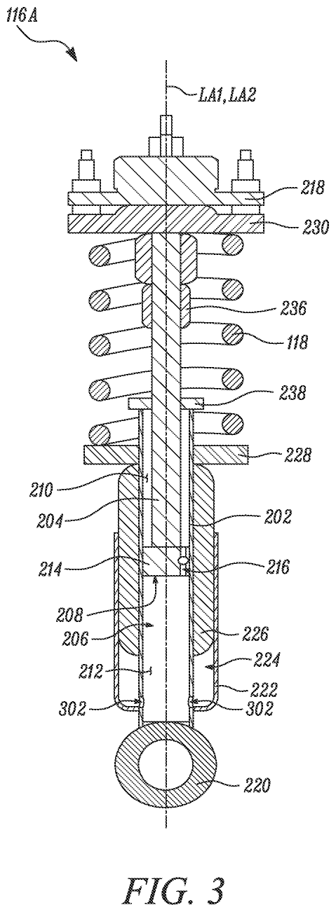

FIG. 3 illustrates a side cross-sectional view of a shock absorber 116A according to an embodiment of the present disclosure. The shock absorber 116A can be used in the vehicle 100 of FIG. 1. The shock absorber 116A is substantially similar to the shock absorber 116 of FIG. 2A, with like elements designated by like reference characters. However, there is no base valve to control fluid flow between the valving piston chamber 206 and the seat piston chamber 224. Instead, the damper tube 202 includes one or more openings 302 fluidly communicating the valving piston chamber 206 with the seat piston chamber 224.

In the compression stroke, the hydraulic fluid in the lower working chamber 212 flows out into the seat piston chamber 224 through the one or more openings 302. In the extension stroke, the hydraulic fluid in the seat piston chamber 224 flows out into the lower working chamber 212 through the one or more openings 302. Thus, the shock absorber 116A is a type of mono-tube style valving shock absorber due to absence of base valve.

In the illustrated embodiment of FIG. 3, the one or more openings 302 include two openings 302 in total. The two openings 302 are angularly spaced apart from each other by 180 degrees about the first longitudinal axis LA1. In some other embodiments, the one or more openings 302 may include more than two openings 302 angularly spaced apart from each other about the first longitudinal axis LA1. Further, functioning and operation of the shock absorber 116A are substantially similar to the functioning and operation of the shock absorber 116 of FIG. 2A.

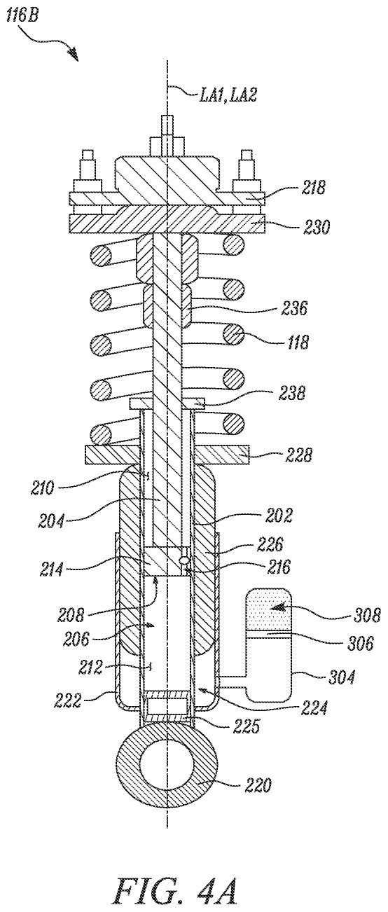

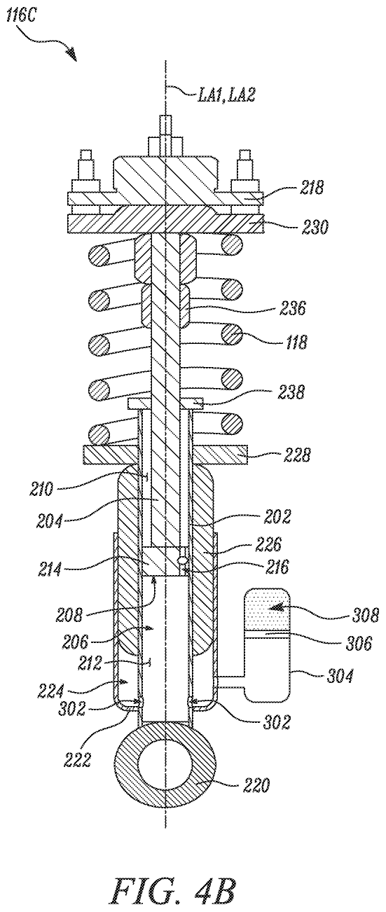

FIG. 4A illustrates a side cross-sectional view of a shock absorber 116B, according to an embodiment of the present disclosure. The shock absorber 116B can be used in the vehicle 100 of FIG. 1. The shock absorber 116B is substantially similar to the shock absorber 116 of FIG. 2A, with like elements designated by like reference characters. However, the shock absorber 116B includes an accumulator 304 disposed in fluid communication with the seat tube 222. In other words, the accumulator 304 is disposed in fluid communication with the seat piston chamber 224. The accumulator 304 includes a diaphragm 306 separating a gas chamber 308 from rest of the accumulator filled with the hydraulic fluid. In some embodiments, with the help of the accumulator 304 and solenoid control units (not shown), movement of the seat piston 226 may be controlled by a control system and other vehicle sensors to further enhance operation of the shock absorber 116B.

Further, the inclusion of the accumulator 304 may increase a durability of sealing (not shown) between the seat piston 226 and the seat tube 222. The accumulator may delay a movement of the seat piston 226 during high frequency low amplitude suspension movements. Moreover, the accumulator 304 may be set up as a high pressure blow off device to prevent sealing rings (not shown) from failing in the shock absorber 116B, if the internal pressures exceed sealing capabilities of the sealing rings. In some embodiments, the accumulator 304 can also be controlled electronically to allow different ride characteristics. In some embodiments, the accumulator 304 may be operated by an externally adjustable spring, or even hydraulically to balance peak pressures in the shock absorber 116B.

FIG. 4B illustrates a side cross-sectional view of a shock absorber 116C, according to an embodiment of the present disclosure. The shock absorber 116C can be used in the vehicle 100 of FIG. 1. The shock absorber 116C is substantially similar to the shock absorber 116A of FIG. 3, with like elements designated by like reference characters. Specifically, the shock absorber 116C includes the one or more openings 302 instead of a base valve. However, the shock absorber 116C includes the accumulator 304 (also shown in FIG. 4A) disposed in fluid communication with the seat tube 222.

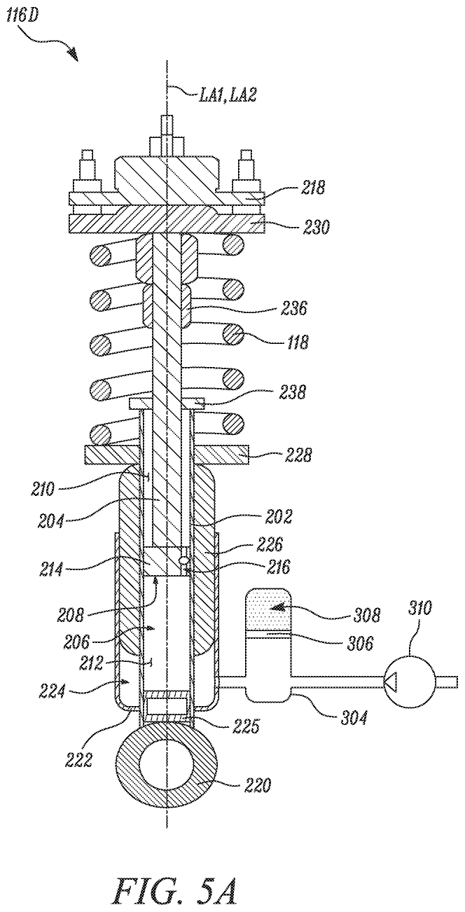

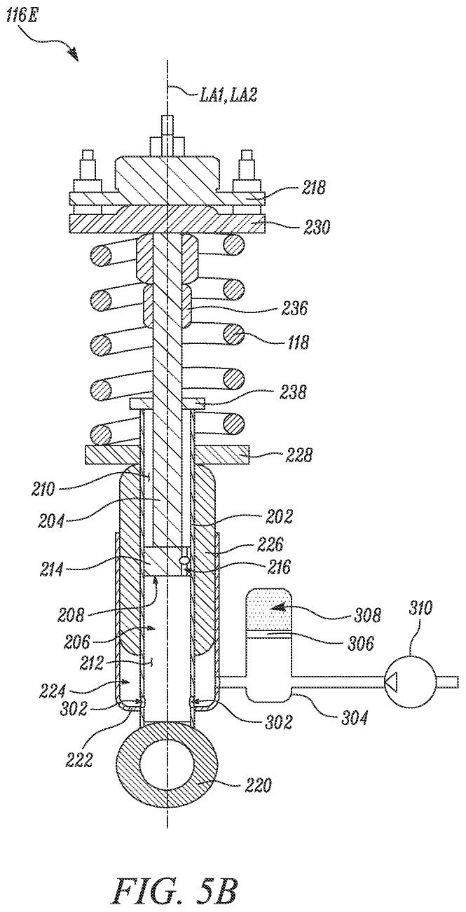

FIG. 5A illustrates a side cross-sectional view of a shock absorber 116D, according to an embodiment of the present disclosure. The shock absorber 116D can be used in the vehicle 100 of FIG. 1. The shock absorber 116D is substantially similar to the shock absorber 116B of FIG. 4A, with like elements designated by like reference characters. However, the shock absorber 116D includes a pump 310 disposed in fluid communication with the seat tube 222. Specifically, the pump 310 is disposed in fluid communication with the seat piston chamber 224. The pump 310 may vary fluid pressure in the shock absorber 116D based on desired application requirements.

FIG. 5B illustrates a side cross-sectional view of a shock absorber 116E, according to an embodiment of the present disclosure. The shock absorber 116E can be used in the vehicle 100 of FIG. 1. The shock absorber 116E is substantially similar to the shock absorber 116C of FIG. 4B, with like elements designated by like reference characters. However, the shock absorber 116E includes the pump 310 disposed in fluid communication with the seat tube 222. The pump 310 may vary fluid pressure in the shock absorber 116E based on desired application requirements.

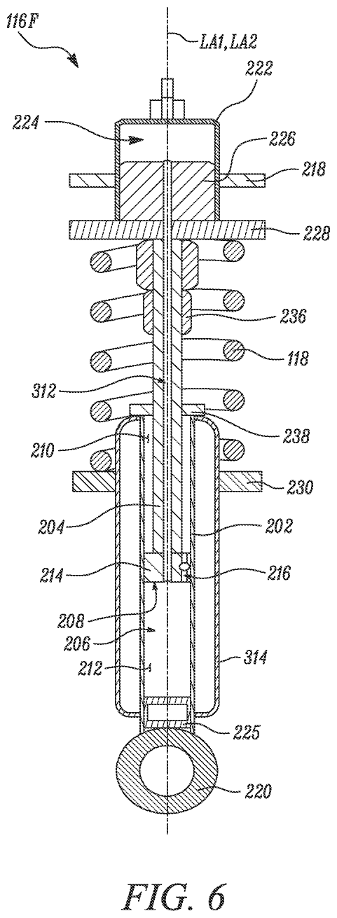

FIG. 6 illustrates a side cross-sectional view of a shock absorber 116F, according to an embodiment of the present disclosure. The shock absorber 116F can be used in the vehicle 100 of FIG. 1. The shock absorber 116F is substantially similar to the shock absorber 116 of FIG. 2A, with like elements designated by like reference characters. However, in the shock absorber 116F, the seat tube 222 is not disposed around the damper tube 202. Further, the seat tube 222 is not fixedly coupled to the damper tube 202. In the illustrated embodiment of FIG. 6, the seat tube 222 is fixedly coupled to the piston rod 204 and spaced apart from the damper tube 202. The seat tube 222 is disposed proximal to the first mount 218 and distal to the second mount 220.

Further, in the shock absorber 116F, the piston rod 204 includes a rod passage 312 extending at least partially along a length of the piston rod 204. The rod passage 312 fluidly communicates the valving piston chamber 206 with the seat piston chamber 224. Specifically, the rod passage 312 fluidly communicates the lower working chamber 212 with the seat piston chamber 224 of the seat tube 222. In contrast to the shock absorber 116 of FIG. 2A, in the shock absorber 116F, each of the seat piston 226 and the first spring seat 228 is slidably mounted around the piston rod 204. Each of the seat piston 226 and the first spring seat 228 is mounted close to the first mount 218. Further, in the shock absorber 116F, the second spring seat 230 is fixedly coupled to the damper tube 202.

With continued reference to FIG. 6, the shock absorber 116F further includes a reserve tube 314 at least partially disposed around the damper tube 202. The shock absorber 116F further includes the base valve 225 fluidly disposed between the valving piston chamber 206 and the reserve tube 314. The base valve 225 is configured to control fluid flow between the valving piston chamber 206 and the reserve tube 314. The reserve tube 314 is used to store excess fluid during suspension movements. Therefore, the shock absorber 116F is a twin-tube style valving shock absorber.

In some embodiments, the shock absorber 116F may also include an accumulator (not shown) disposed in fluid communication with the seat tube 222. In some embodiments, the accumulator may be in direct fluid communication with the seat tube 222. In some embodiments, the accumulator may be indirectly fluidly communicated with the seat tube 222.

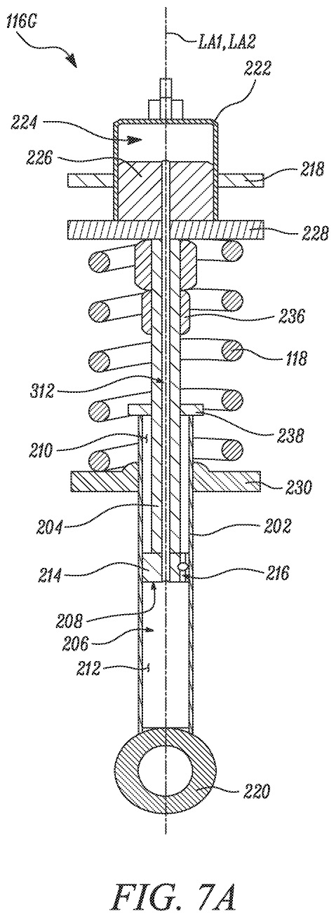

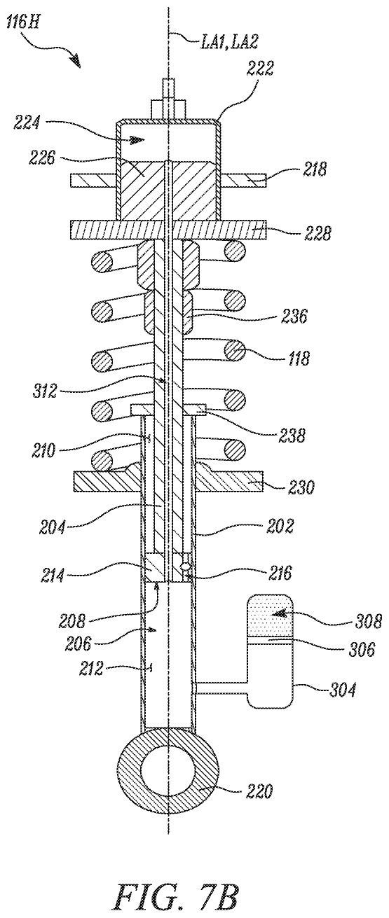

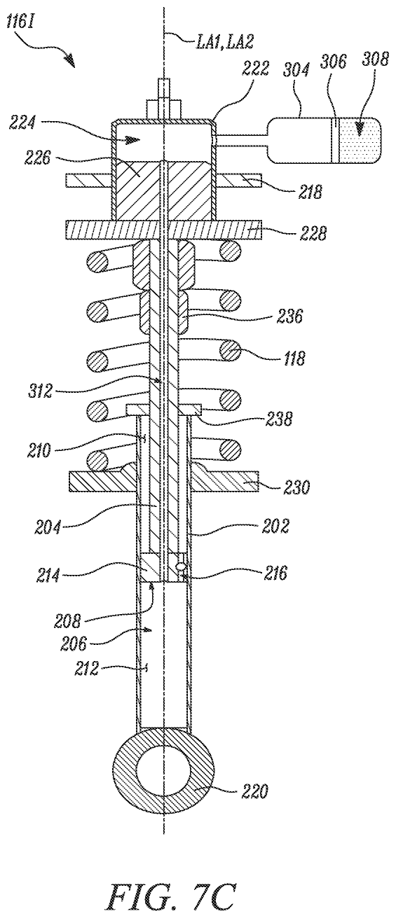

FIG. 7A illustrates a side cross-sectional view of a shock absorber 116G, according to an embodiment of the present disclosure. The shock absorber 116G can be used in the vehicle 100 of FIG. 1. The shock absorber 116G is substantially similar to the shock absorber 116F of FIG. 6, with like elements designated by like reference characters. However, the shock absorber 116G does not include a reserve tube in contrast to the shock absorber 116F of FIG. 6. Therefore, there is no base valve in the shock absorber 116G. Hence, the shock absorber 116G is a mono-tube style valving shock absorber due to absence of the base valve and the reserve tube.

FIG. 7B illustrates a side cross-sectional view of a shock absorber 116H, according to an embodiment of the present disclosure. The shock absorber 116H can be used in the vehicle 100 of FIG. 1. The shock absorber 116H is substantially similar to the shock absorber 116G of FIG. 7A, with like elements designated by like reference characters. However, the shock absorber 116H includes the accumulator 304 (also shown in FIGS. 4A-4B, 5A-5B) disposed in fluid communication with the seat tube 222. Specifically, the accumulator 304 is disposed in fluid communication with the seat tube 222 via the rod passage 312 and the lower working chamber 212 of the valving piston chamber 206. Therefore, in the shock absorber 116H, the accumulator 304 is disposed in indirect fluid communication with the seat tube 222. The accumulator 304 is disposed proximal to the second mount 220 and distal to the first mount 218.

FIG. 7C illustrates a side cross-sectional view of a shock absorber 116I, according to an embodiment of the present disclosure. The shock absorber 116I can be used in the vehicle 100 of FIG. 1. The shock absorber 116I is substantially similar to the shock absorber 116G of FIG. 7A, with like elements designated by like reference characters. However, the shock absorber 116I includes the accumulator 304 (also shown in FIGS. 4A-4B, 5A-5B) disposed in fluid communication with the seat tube 222. The accumulator 304 is disposed in fluid communication with the valving piston chamber 206 via the seat tube 222 and the rod passage 312. Therefore, in the shock absorber 116I, the accumulator 304 is disposed in direct fluid communication with the seat tube 222. The accumulator 304 is disposed proximal to the first mount 218 and distal to the second mount 220.

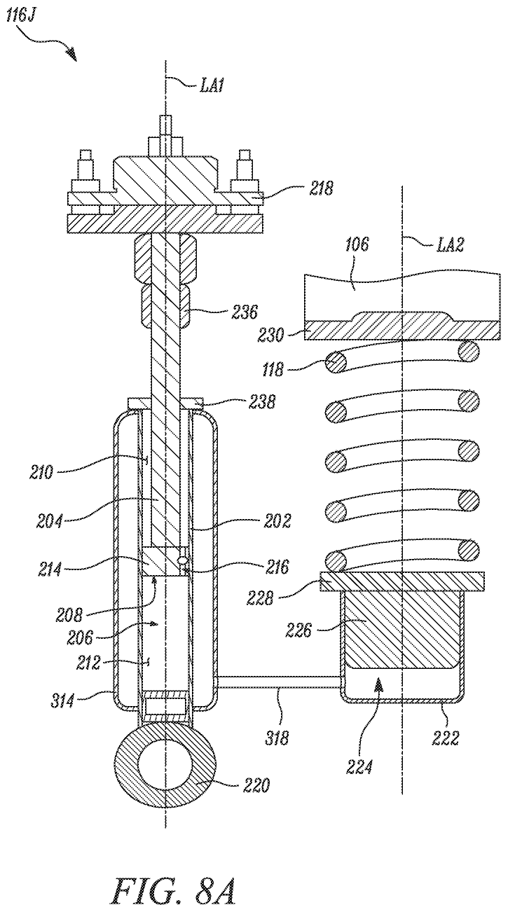

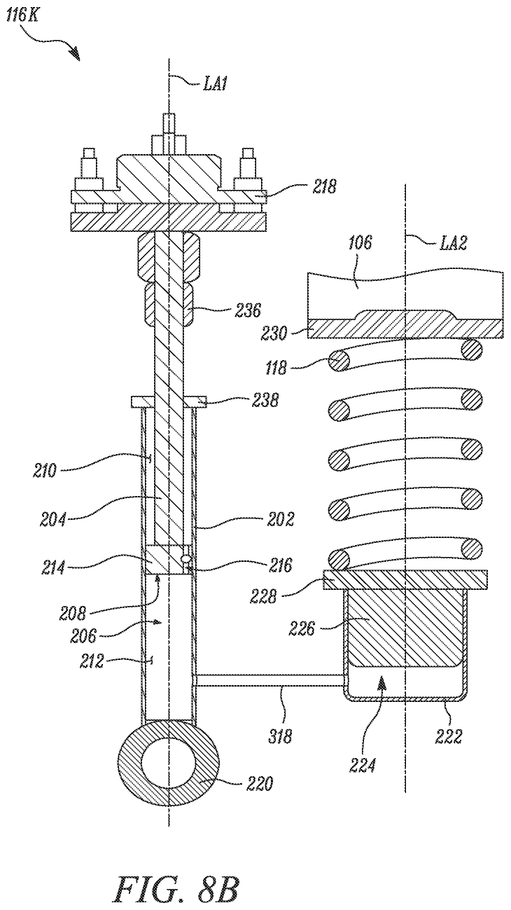

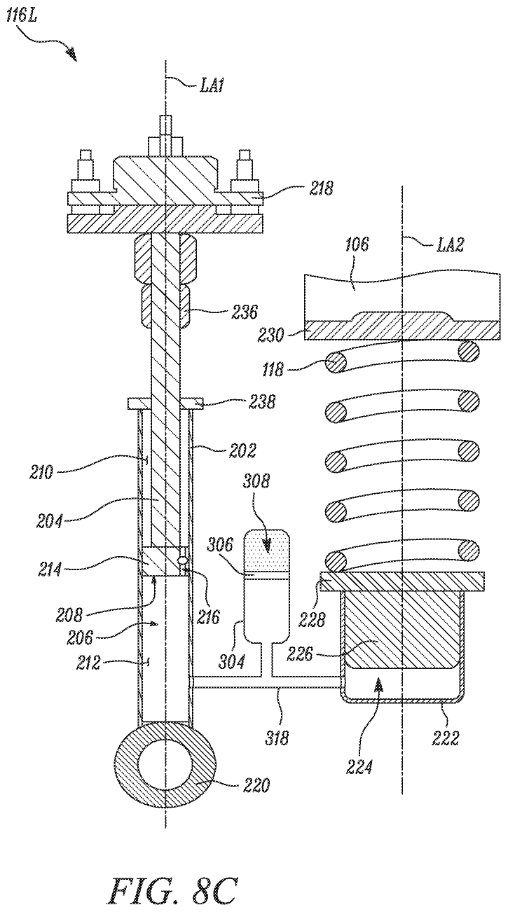

FIG. 8A illustrates a side cross-sectional view of a shock absorber 116J, according to an embodiment of the present disclosure. The shock absorber 116J can be used in the vehicle 100 of FIG. 1. In some cases, the shock absorber 116J can be used as the shock absorber 110 of the rear suspension 102 of the vehicle 100. In such cases, the spring 118 shown in FIG. 8A may correspond to the spring 112 of the rear suspension 102. The shock absorber 116J is substantially similar to the shock absorber 116 of FIG. 2A, with like elements designated by like reference characters. However, the shock absorber 116J includes the reserve tube 314 (also shown in FIG. 6) at least partially disposed around the damper tube 202. The shock absorber 116J further includes the base valve 225 fluidly disposed between the valving piston chamber 206 and the reserve tube 314. The base valve 225 is configured to control fluid flow between the valving piston chamber 206 and the reserve tube 314. Therefore, the shock absorber 116J is a twin-tube style valving shock absorber.

The shock absorber 116J further includes a fluid conduit 318 extending from the damper tube 202 and fluidly communicating the valving piston chamber 206 with the seat piston chamber 224. Specifically, the fluid conduit 318 extends from the reserve tube 314 and fluidly communicates the valving piston chamber 206 with the seat piston chamber 224 via the reserve tube 314. In other words, the fluid conduit 318 is disposed in fluid communication with the reserve tube 314 and the seat piston chamber 224. Therefore, in the shock absorber 116J, the seat tube 222 is disposed in indirect fluid communication with the damper tube 202, via the fluid conduit 318 and the reserve tube 314. Further, each of the seat tube 222, the first spring seat 228, and the second spring seat 230 is remote from the damper tube 202. The second spring seat 230 is fixedly coupled to the sprung portion 106 of the vehicle 100.

With continued reference to FIG. 8A, each of the seat piston 226 and the first spring seat 228 is configured to move along the second longitudinal axis LA2 based on the pressure of the hydraulic fluid within the seat tube 222. However, during suspension movements, the valving piston assembly 208 is configured to move along the first longitudinal axis LA1 relative to the damper tube 202. Therefore, in the illustrated embodiment of FIG. 8A, the second longitudinal axis LA2 is parallelly offset from the first longitudinal axis LA1.

FIG. 8B illustrates a side cross-sectional view of a shock absorber 116K, according to an embodiment of the present disclosure. The shock absorber 116K can be used in the vehicle 100 of FIG. 1. In some cases, the shock absorber 116K can be used as the shock absorber 110 of the rear suspension 102 of the vehicle 100. In such cases, the spring 118 shown in FIG. 8B may correspond to the spring 112 of the rear suspension 102. The shock absorber 116K is substantially similar to the shock absorber 116J of FIG. 8A, with like elements designated by like reference characters. However, the shock absorber 116K does not include a reserve tube in contrast to the shock absorber 116J of FIG. 8A. Therefore, there is no base valve in the shock absorber 116K. Hence, the shock absorber 116K is a mono-tube style valving shock absorber due to absence of the base valve and the reserve tube. Further, in the shock absorber 116K, the fluid conduit 318 extends from the damper tube 202 and fluidly communicates the valving piston chamber 206 with the seat piston chamber 224.

FIG. 8C illustrates a side cross-sectional view of a shock absorber 116L, according to an embodiment of the present disclosure. The shock absorber 116L can be used in the vehicle 100 of FIG. 1. In some cases, the shock absorber 116L can be used as the shock absorber 110 of the rear suspension 102 of the vehicle 100. In such cases, the spring 118 shown in FIG. 8C may correspond to the spring 112 of the rear suspension 102. The shock absorber 116L is substantially similar to the shock absorber 116K of FIG. 8B, with like elements designated by like reference characters. However, the shock absorber 116L includes the accumulator 304 (also shown in FIGS. 4A-4B, 5A-5B, and 7B-7C) disposed in fluid communication with the seat tube 222. Specifically, the accumulator 304 is disposed in fluid communication with the seat tube 222 via the fluid conduit 318. Therefore, in the shock absorber 116L, the accumulator 304 is disposed in fluid communication with the fluid conduit 318. Further, the accumulator 304 is disposed between the damper tube 202 and the seat tube 222.

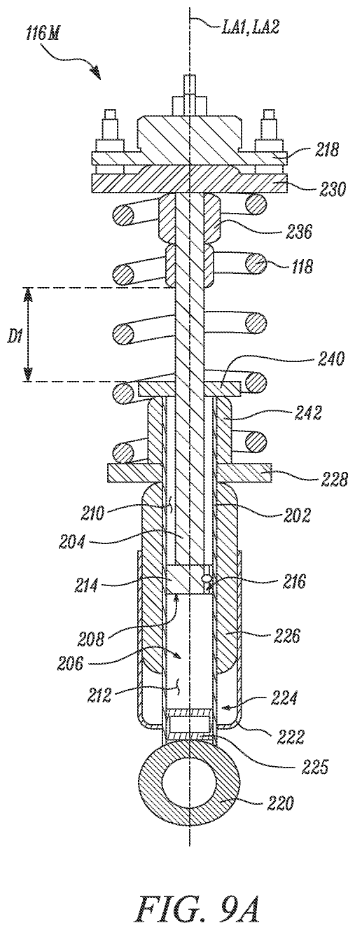

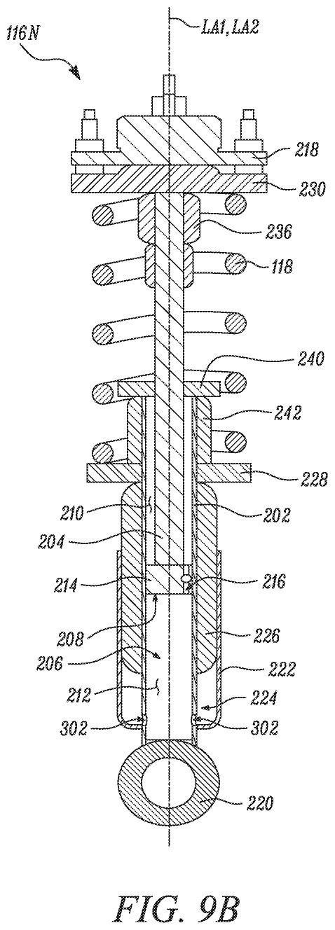

FIG. 9A illustrates a side cross-sectional view of a shock absorber 116M, according to an embodiment of the present disclosure. The shock absorber 116M can be used in the vehicle 100 of FIG. 1. The shock absorber 116M is substantially similar to the shock absorber 116 of FIG. 2A, with like elements designated by like reference characters. However, the shock absorber 116M does not include a striker member.

The shock absorber 116M includes a bumper seat 240 slidably mounted around the piston rod 204. The bumper seat 240 is fixedly coupled to at least one of the seat piston 226 and the first spring seat 228 for movement with the seat piston 226 along the second longitudinal axis LA2. Specifically, the shock absorber 116M includes a bumper sleeve 242 configured to fixedly couple the bumper seat 240 to the at least one of the seat piston 226 and the first spring seat 228. The bumper sleeve 242 is slidably mounted at least partially around the damper tube 202 and axially disposed between the first spring seat 228 and the bumper seat 240. In the illustrated embodiment of FIG. 9A, the bumper seat 240 is fixedly coupled to the first spring seat 228. In other words, as shown in FIG. 9A, the bumper sleeve 242 fixedly couples the bumper seat 240 to the first spring seat 228.

The bumper seat 240 is configured to selectively engage with the jounce bumper 236 in response to a relative movement of the seat piston 226 and the jounce bumper 236 towards each other. Specifically, during the compression stroke, the jounce bumper 236 is configured to engage with the bumper seat 240.

During the compression stroke of the shock absorber 116M, fluid pressure builds up in the lower working chamber 212 of the valving piston chamber 206. Due to this pressure build up, some of the hydraulic fluid in the lower working chamber 212 flows out into the seat piston chamber 224 through the base valve 225. This fluid movement increases the pressure of the hydraulic fluid within the seat tube 222. The increased fluid pressure within the seat tube 222 causes the seat piston 226 to move towards the second spring seat 230 along the second longitudinal axis LA2. As the first spring seat 228 is fixedly coupled to the seat piston 226, the first spring seat 228 is also moved towards the jounce bumper 236 along the second longitudinal axis LA2 upon movement of the seat piston 226 towards the second spring seat 230. Further, as the bumper seat 240 is fixedly coupled to at least one of the seat piston 226 and the first spring seat 228, the bumper seat 240 is also moved towards the jounce bumper 236. A relative movement of the bumper seat 240 and the jounce bumper 236 towards each other causes the engagement of the bumper seat 240 and the jounce bumper 236, which may prevent bottoming out of the shock absorber 116M.

Therefore, during the compression stroke of the shock absorber 116M, for a given movement of the piston rod 204, a distance D1 (shown in FIG. 9A) between the jounce bumper 236 and the bumper seat 240 is decreased to a greater degree as compared to conventional shock absorbers. This may cause a relatively early engagement of the jounce bumper 236 with the bumper seat 240, as compared to the conventional shock absorbers having jounce bumpers. Therefore, the shock absorber 116M with the seat piston 226, the bumper seat 240, and the seat tube 222 may have a minimal possibility of the bottoming out, and hence, may significantly improve a ride quality, a steering response, and an overall stability of the vehicle 100. Further, characteristics of the spring 118 are identical in the shock absorber 116 (shown in FIG. 2A) as well as the shock absorber 116M. Therefore, the shock absorber 116M is a height responsive shock absorber as well as an anti-bottoming shock absorber.

FIG. 9B illustrates a side cross-sectional view of a shock absorber 116N, according to an embodiment of the present disclosure. The shock absorber 116N can be used in the vehicle 100 of FIG. 1. The shock absorber 116N is substantially similar to the shock absorber 116M of FIG. 9A, with like elements designated by like reference characters. However, there is no base valve to control fluid flow between the valving piston chamber 206 and the seat piston chamber 224. Instead, in the shock absorber 116N, the damper tube 202 includes the one or more openings 302 (also shown in FIGS. 3, 4B, 5B) fluidly communicating the valving piston chamber 206 with the seat piston chamber 224.

In the illustrated embodiment of FIG. 9B, the one or more openings 302 include two openings 302 in total. The two openings 302 are angularly spaced apart from each other by 180 degrees about the first longitudinal axis LA1. In some other embodiments, the one or more openings 302 may include more than two openings 302 angularly spaced apart from each other about the first longitudinal axis LA1. Further, functioning and operation of the shock absorber 116N are substantially similar to the functioning and operation of the shock absorber 116M of FIG. 9A.

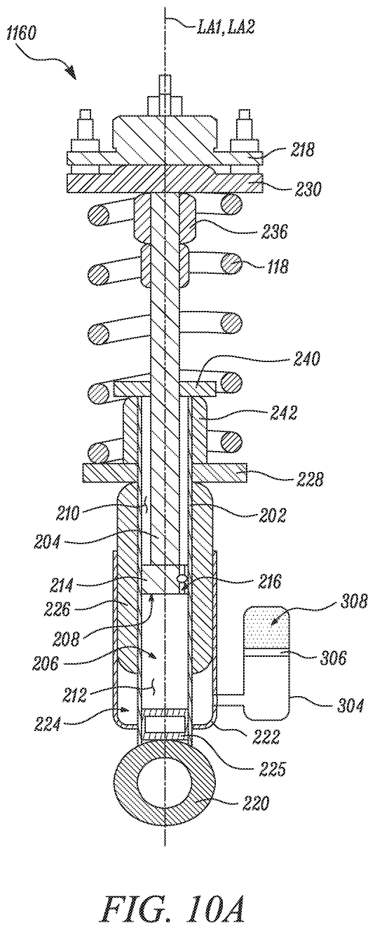

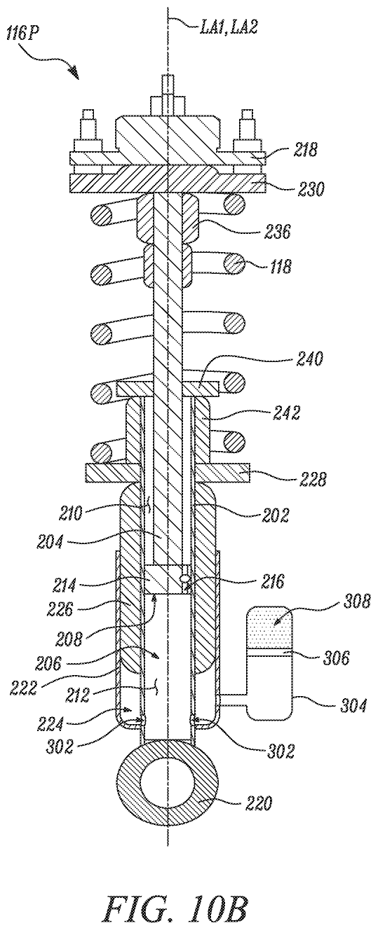

FIG. 10A illustrates a side cross-sectional view of a shock absorber 116O, according to an embodiment of the present disclosure. The shock absorber 116O can be used in the vehicle 100 of FIG. 1. The shock absorber 116O is substantially similar to the shock absorber 116M of FIG. 9A, with like elements designated by like reference characters. However, the shock absorber 116O includes the accumulator 304 (also shown in FIGS. 4A-4B, 5A-5B, 7B-7C, 8C) disposed in fluid communication with the seat tube 222. In other words, the accumulator 304 is disposed in fluid communication with the seat piston chamber 224. The accumulator 304 is disposed proximal to the second mount 220 and distal to the first mount 218.

FIG. 10B illustrates a side cross-sectional view of a shock absorber 116P, according to an embodiment of the present disclosure. The shock absorber 116P can be used in the vehicle 100 of FIG. 1. The shock absorber 116P is substantially similar to the shock absorber 116N of FIG. 9B, with like elements designated by like reference characters. Specifically, the shock absorber 116P includes the one or more openings 302 fluidly communicating the valving piston chamber 206 with the seat piston chamber 224 instead of a base valve. However, the shock absorber 116P includes the accumulator 304 (also shown in FIG. 10A) disposed in fluid communication with the seat tube 222.

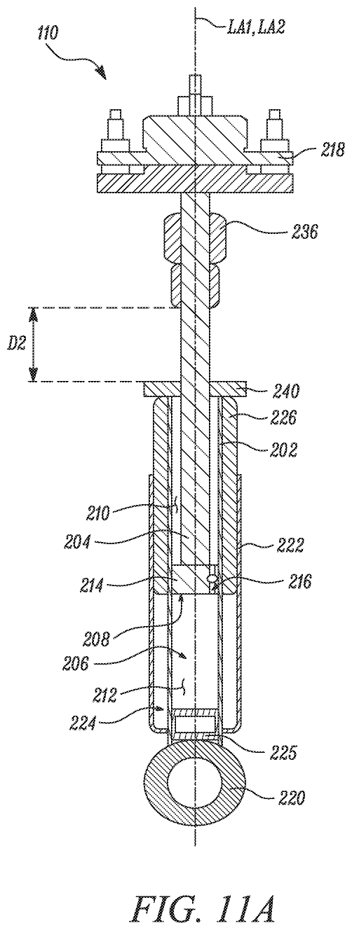

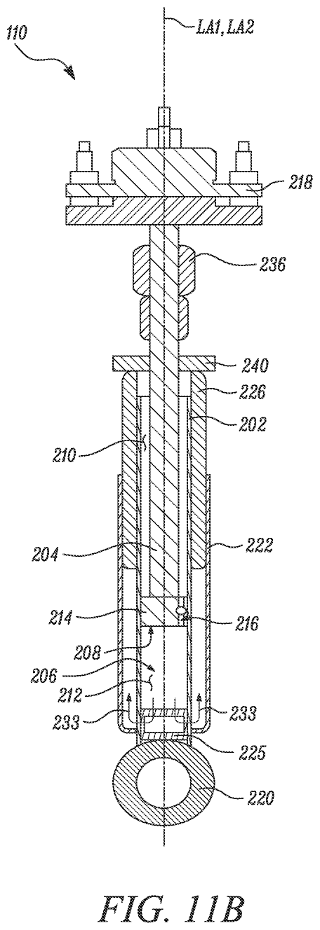

FIG. 11A illustrates a side cross-sectional view of the shock absorber 110, according to an embodiment of the present disclosure. The shock absorber 110 is substantially similar to the shock absorber 116 of FIG. 2A, with like elements designated by like reference characters. However, the shock absorber 110 does not include a spring and corresponding spring seats for the spring, as compared to the shock absorber 116 of FIG. 2A.

Further, the shock absorber 110 includes the bumper seat 240 (also shown in FIG. 9A) fixedly coupled to the seat piston 226 for movement with the seat piston 226 along the second longitudinal axis LA2. The shock absorber 110 further includes the jounce bumper 236 (also shown in FIG. 9A) fixedly coupled to one of the piston rod 204 and the bumper seat 240. In the illustrated embodiment of FIG. 11A, the jounce bumper 236 is disposed around and fixedly coupled to the piston rod 204. Specifically, the jounce bumper 236 is normally held in place by friction between the jounce bumper 236 and the piston rod 204. In some cases, the jounce bumper 236 is fixedly coupled to the first mount 218. Further, as shown in FIG. 11A, the bumper seat 240 is slidably mounted around the piston rod 204. The seat piston 226 is slidably mounted at least partially around the damper tube 202.

FIG. 11B illustrates the shock absorber 110 in a compressed position, according to an embodiment of the present disclosure. During a compression stroke of the shock absorber 110, fluid pressure builds up in the lower working chamber 212 of the valving piston chamber 206. Due to this pressure build up, some of the hydraulic fluid in the lower working chamber 212 flows out into the seat piston chamber 224 through the base valve 225. Movement of hydraulic fluid from the lower working chamber 212 to the seat piston chamber 224 of the seat tube 222 is shown by a flow path 233. This fluid movement increases the pressure of the hydraulic fluid within the seat tube 222. The increased fluid pressure within the seat tube 222 causes the seat piston 226 to move towards the jounce bumper 236 along the second longitudinal axis LA2. As the bumper seat 240 is fixedly coupled to the seat piston 226, the bumper seat 240 is also moved towards the jounce bumper 236 along the second longitudinal axis LA2 upon movement of the seat piston 226 towards the jounce bumper 236.

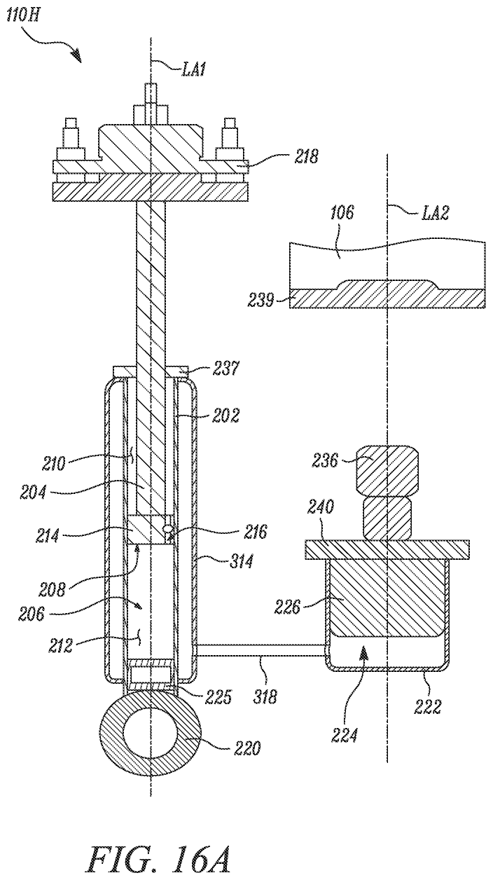

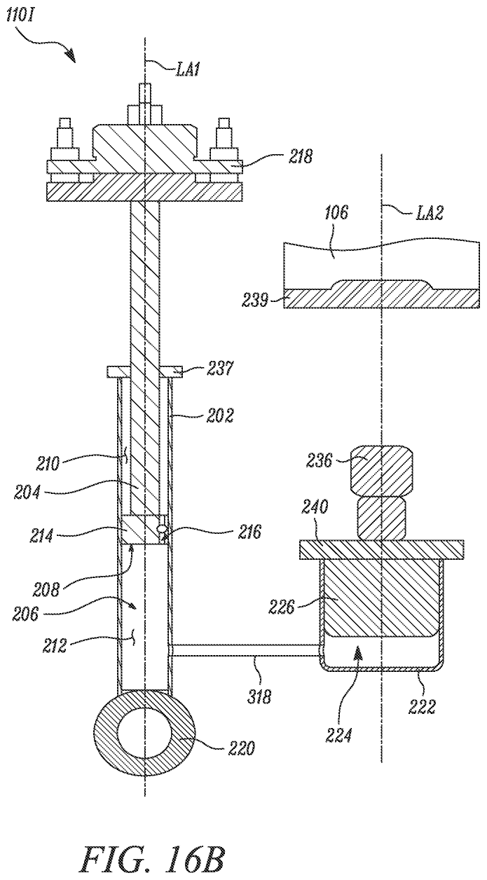

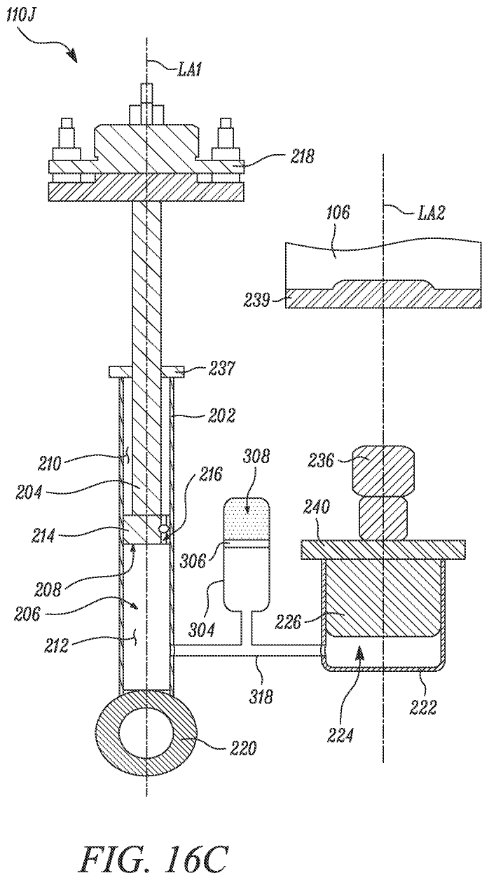

Further, during the compression stroke of the shock absorber 116, the piston rod 204 travels towards the second mount 220 and therefore, the jounce bumper 236 is moved towards one of the bumper seat 240 and a striker member 239 (shown in FIG. 16A). In the illustrated embodiments of FIGS. 11A and 11B, the jounce bumper 236 is configured to move towards the bumper seat 240 in the compression stroke of the shock absorber 110. Hence, movement of the bumper seat 240 and the jounce bumper 236 towards each other results in engagement of the bumper seat 240 with the jounce bumper 236. In other words, during the compression stroke, a distance D2 between the jounce bumper 236 and the bumper seat 240 is decreased to a greater degree as compared to the conventional shock absorbers. This may cause a relatively early engagement of the jounce bumper 236 with the bumper seat 240, as compared to the conventional shock absorbers having jounce bumpers. Therefore, the shock absorber 110 with the seat piston 226, the bumper seat 240, and the seat tube 222 may have a minimal possibility of the bottoming out, and hence, may significantly improve a ride quality, a steering response, and an overall stability of the vehicle 100. Hence, the shock absorber 110 is an anti-bottoming shock absorber.

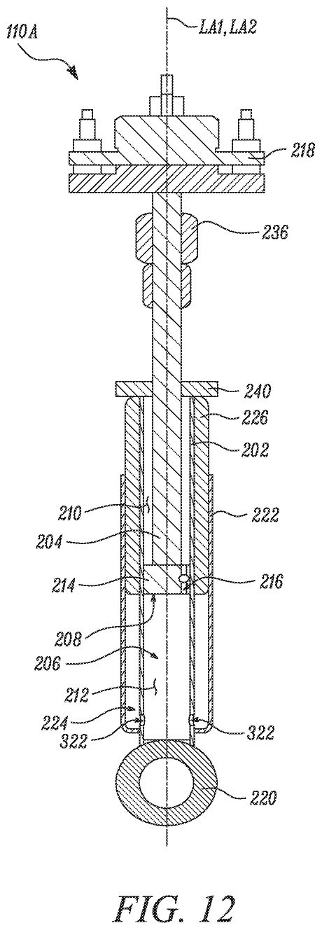

FIG. 12 illustrates a side cross-sectional view of a shock absorber 110A, according to an embodiment of the present disclosure. The shock absorber 110A can be used in the vehicle 100 of FIG. 1. The shock absorber 110A is substantially similar to the shock absorber 110 of FIG. 11A, with like elements designated by like reference characters. However, there is no base valve to control fluid flow between the valving piston chamber 206 and the seat piston chamber 224. Instead, in the shock absorber 110A, the damper tube 202 includes one or more openings 322 fluidly communicating the valving piston chamber 206 with the seat piston chamber 224.

In the illustrated embodiment of FIG. 12, the one or more openings 322 include two openings 322 in total. The two openings 322 are angularly spaced apart from each other by 180 degrees about the first longitudinal axis LA1. In some other embodiments, the one or more openings 322 may include more than two openings 322 angularly spaced apart from each other about the first longitudinal axis LA1. Further, functioning and operation of the shock absorber 110A are substantially similar to the functioning and operation of the shock absorber 110 of FIG. 11A.

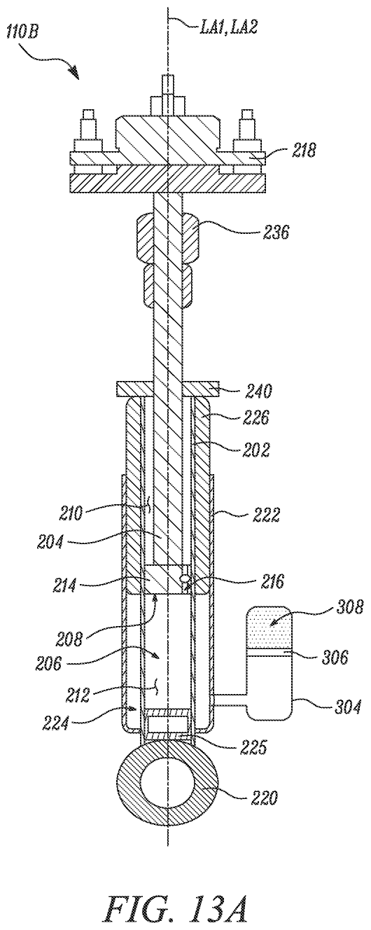

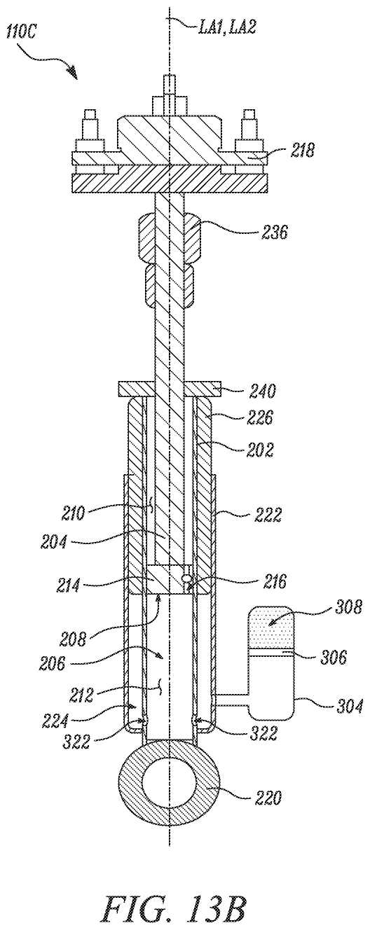

FIG. 13A illustrates a side cross-sectional view of a shock absorber 110B, according to an embodiment of the present disclosure. The shock absorber 110B can be used in the vehicle 100 of FIG. 1. The shock absorber 110B is substantially similar to the shock absorber 110 of FIG. 11A, with like elements designated by like reference characters. However, the shock absorber 110B includes the accumulator 304 (also shown in FIGS. 4A-4B, 5A-5B, 7B-7C, 8C, 10A-10B) disposed in fluid communication with the seat tube 222. In other words, the accumulator 304 is disposed in fluid communication with the seat piston chamber 224. The accumulator 304 is disposed proximal to the second mount 220 and distal to the first mount 218.

FIG. 13B illustrates a side cross-sectional view of a shock absorber 110C, according to an embodiment of the present disclosure. The shock absorber 110C can be used in the vehicle 100 of FIG. 1. The shock absorber 110C is substantially similar to the shock absorber 110A of FIG. 12, with like elements designated by like reference characters. Specifically, the shock absorber 110C includes the one or more openings 322 fluidly communicating the valving piston chamber 206 with the seat piston chamber 224 instead of a base valve. However, the shock absorber 110C includes the accumulator 304 (also shown in FIG. 13A) disposed in fluid communication with the seat tube 222.

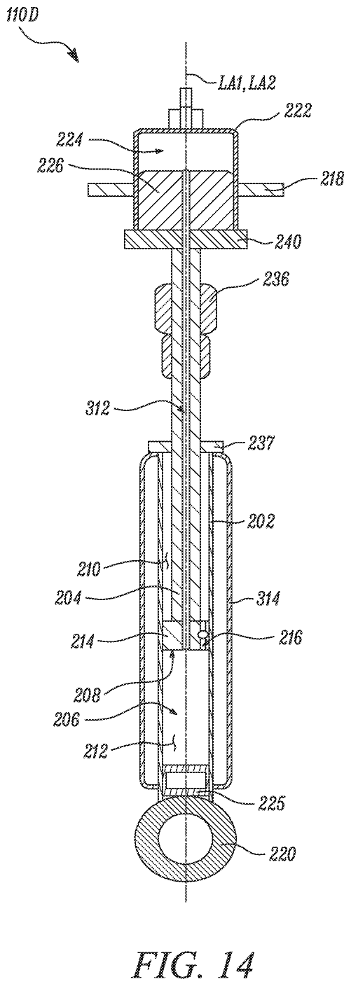

FIG. 14 illustrates a side cross-sectional view of a shock absorber 110D, according to an embodiment of the present disclosure. The shock absorber 110D can be used in the vehicle 100 of FIG. 1. The shock absorber 110D is substantially similar to the shock absorber 110 of FIG. 11A, with like elements designated by like reference characters. However, in the shock absorber 110D, the seat tube 222 is not disposed around and fixedly coupled to the damper tube 202. In the illustrated embodiment of FIG. 14, the seat tube 222 is fixedly coupled to the piston rod 204 and spaced apart from the damper tube 202. The seat tube 222 is disposed proximal to the first mount 218 and distal to the second mount 220. The jounce bumper 236 is configured to contact a surface of a striker member 237 during the compression stroke of the shock absorber 110D.

Further, in the shock absorber 110D, the piston rod 204 includes the rod passage 312 (also shown in FIG. 6) extending at least partially along the length of the piston rod 204. The rod passage 312 fluidly communicates the valving piston chamber 206 with the seat piston chamber 224. Specifically, the rod passage 312 fluidly communicates the lower working chamber 212 with the seat piston chamber 224 of the seat tube 222. In contrast to the shock absorber 110 of FIG. 11A, in the shock absorber 110D, each of the seat piston 226 and the bumper seat 240 is slidably mounted around the piston rod 204. Each of the seat piston 226 and the bumper seat 240 is mounted close to the first mount 218.

With continued reference to FIG. 14, the shock absorber 110D further includes the reserve tube 314 (also shown in FIG. 8A) at least partially disposed around the damper tube 202. The shock absorber 110D further includes the base valve 225 fluidly disposed between the valving piston chamber 206 and the reserve tube 314. The base valve 225 is configured to control fluid flow between the valving piston chamber 206 and the reserve tube 314. The reserve tube 314 is used to store excess fluid during suspension movements. Therefore, the shock absorber 110D is a twin-tube style valving shock absorber.

In some embodiments, the shock absorber 110D may also include an accumulator (not shown) disposed in fluid communication with the seat tube 222. In some embodiments, the accumulator may be in direct fluid communication with the seat tube 222. In some embodiments, the accumulator may be indirectly fluidly communicated with the seat tube 222.

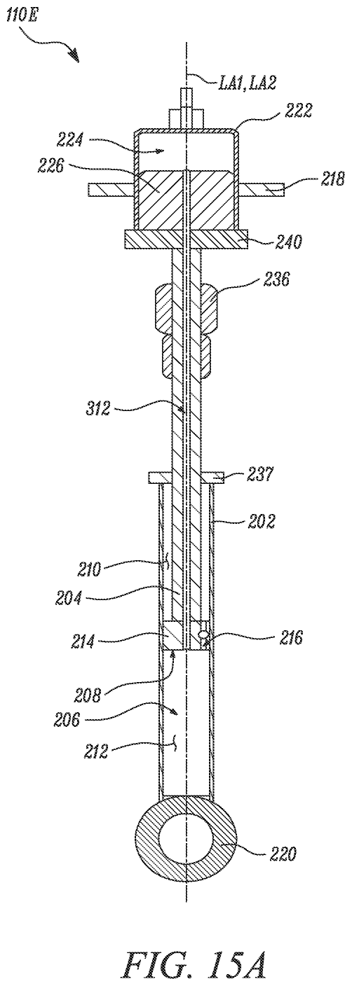

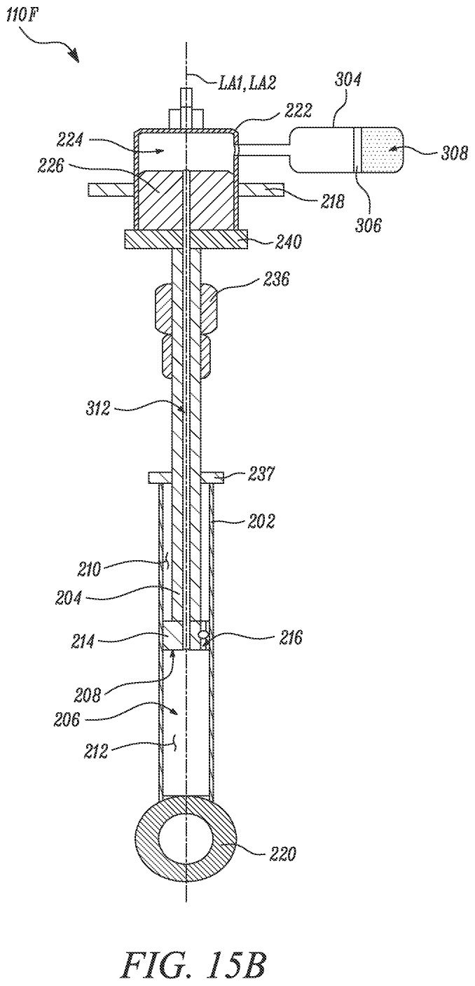

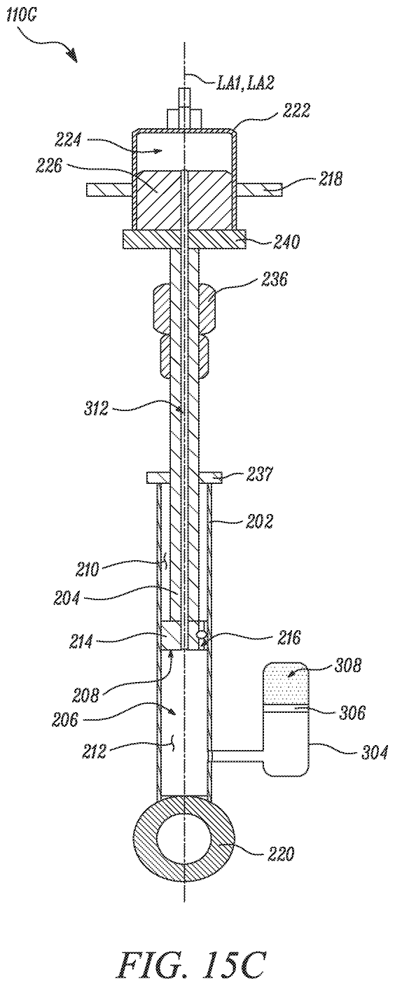

FIG. 15A illustrates a side cross-sectional view of a shock absorber 110E, according to an embodiment of the present disclosure. The shock absorber 110E can be used in the vehicle 100 of FIG. 1. The shock absorber 110E is substantially similar to the shock absorber 110D of FIG. 14, with like elements designated by like reference characters. However, the shock absorber 110E does not include a reserve tube in contrast to the shock absorber 110D of FIG. 14. Therefore, there is no base valve in the shock absorber 110E. Hence, the shock absorber 116E is a mono-tube style valving shock absorber due to absence of the base valve and the reserve tube.

FIG. 15B illustrates a side cross-sectional view of a shock absorber 110F, according to an embodiment of the present disclosure. The shock absorber 110F can be used in the vehicle 100 of FIG. 1. The shock absorber 110F is substantially similar to the shock absorber 110E of FIG. 15A, with like elements designated by like reference characters. However, the shock absorber 110F includes the accumulator 304 (also shown in FIGS. 13A-13B) disposed in fluid communication with the seat tube 222. The accumulator 304 is disposed in fluid communication with the valving piston chamber 206 via the seat tube 222 and the rod passage 312. Therefore, in the shock absorber 110F, the accumulator 304 is disposed in direct fluid communication with the seat tube 222. The accumulator 304 is disposed proximal to the first mount 218 and distal to the second mount 220.

FIG. 15C illustrates a side cross-sectional view of a shock absorber 110G, according to an embodiment of the present disclosure. The shock absorber 110G can be used in the vehicle 100 of FIG. 1. The shock absorber 110G is substantially similar to the shock absorber 110E of FIG. 15A, with like elements designated by like reference characters. However, the shock absorber 110G includes the accumulator 304 (also shown in FIGS. 13A-13B) disposed in fluid communication with the seat tube 222. Specifically, the accumulator 304 is disposed in fluid communication with the seat tube 222 via the rod passage 312 and the lower working chamber 212 of the valving piston chamber 206. Therefore, in the shock absorber 110G, the accumulator 304 is disposed in indirect fluid communication with the seat tube 222. The accumulator 304 is disposed proximal to the second mount 220 and distal to the first mount 218.

FIG. 16A illustrates a side cross-sectional view of a shock absorber 110H, according to an embodiment of the present disclosure. The shock absorber 110H can be used in the vehicle 100 of FIG. 1. The shock absorber 110H is substantially similar to the shock absorber 110 of FIG. 11A, with like elements designated by like reference characters. However, the shock absorber 110H includes the reserve tube 314 (also shown in FIG. 14) at least partially disposed around the damper tube 202. The shock absorber 110H further includes the base valve 225 fluidly disposed between the valving piston chamber 206 and the reserve tube 314. The base valve 225 is configured to control fluid flow between the valving piston chamber 206 and the reserve tube 314. Therefore, the shock absorber 110H is a twin-tube style valving shock absorber.

The shock absorber 110H further includes the fluid conduit 318 (also shown in FIG. 8A) extending from the damper tube 202 and fluidly communicating the valving piston chamber 206 with the seat piston chamber 224. Specifically, the fluid conduit 318 extends from the reserve tube 314 and fluidly communicates the valving piston chamber 206 with the seat piston chamber 224 via the reserve tube 314. In other words, the fluid conduit 318 is disposed in fluid communication with the reserve tube 314 and the seat piston chamber 224. Therefore, in the shock absorber 110H, the seat tube 222 is disposed in indirect fluid communication with the damper tube 202, via the fluid conduit 318 and the reserve tube 314. Further, each of the seat tube 222, the bumper seat 240, and the jounce bumper 236 is remote from the damper tube 202. The jounce bumper 236 is fixedly coupled to the bumper seat 240.

The jounce bumper 236 is configured to selectively engage with the striker member 239 fixedly coupled to the sprung portion 106 of the vehicle 100 in response to a relative movement of the striker member 239 and the jounce bumper 236 towards each other along the second longitudinal axis LA2. Specifically, during the compression stroke, the jounce bumper 236 engages with the bumper seat 240. The relative movement of the bumper seat 240 and the jounce bumper 236 towards each other causes the engagement of the bumper seat 240 and the jounce bumper 236, which may prevent bottoming out of the shock absorber 110H.

With continued reference to FIG. 16A, each of the seat piston 226 and the bumper seat 240 is configured to move along the second longitudinal axis LA2 based on the pressure of the hydraulic fluid within the seat tube 222. However, during suspension movements, the valving piston assembly 208 is configured to move along the first longitudinal axis LA1 relative to the damper tube 202. Therefore, in the illustrated embodiment of FIG. 8A, the second longitudinal axis LA2 is parallelly offset from the first longitudinal axis LA1.

FIG. 16B illustrates a side cross-sectional view of a shock absorber 110I, according to an embodiment of the present disclosure. The shock absorber 110I can be used in the vehicle 100 of FIG. 1. The shock absorber 110I is substantially similar to the shock absorber 110H of FIG. 16A, with like elements designated by like reference characters. However, the shock absorber 110I does not include a reserve tube in contrast to the shock absorber 110H of FIG. 16A. Therefore, there is no base valve in the shock absorber 110I. Hence, the shock absorber 110I is a mono-tube style valving shock absorber due to absence of the base valve and the reserve tube. Further, in the shock absorber 110I, the fluid conduit 318 extends from the damper tube 202 and fluidly communicates the valving piston chamber 206 with the seat piston chamber 224.

FIG. 16C illustrates a side cross-sectional view of a shock absorber 110J, according to an embodiment of the present disclosure. The shock absorber 110J can be used in the vehicle 100 of FIG. 1. The shock absorber 110J is substantially similar to the shock absorber 110I of FIG. 16B, with like elements designated by like reference characters. However, the shock absorber 110J includes the accumulator 304 (also shown in FIGS. 13A-13B and 15B-15C) disposed in fluid communication with the seat tube 222. Specifically, the accumulator 304 is disposed in fluid communication with the seat tube 222 via the fluid conduit 318. Therefore, in the shock absorber 110J, the accumulator 304 is disposed in fluid communication with the fluid conduit 318. Further, the accumulator 304 is disposed between the damper tube 202 and the seat tube 222.

While aspects of the present disclosure have been particularly shown and described with reference to the embodiments above, it will be understood by those skilled in the art that various additional embodiments can be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A shock absorber for use with a sprung portion and an unsprung portion of a vehicle, the shock absorber comprising:
a damper tube defining a valving piston chamber containing a hydraulic fluid;
a piston rod extending within the damper tube along a first longitudinal axis;
a valving piston assembly slidably fitted in the damper tube for movement along the first longitudinal axis relative to the damper tube, wherein the valving piston assembly is coupled to the piston rod;
a seat tube disposed in fluid communication with the valving piston chamber and configured to receive the hydraulic fluid from the valving piston chamber, the seat tube defining a seat piston chamber therein;
a seat piston slidably fitted at least partially in the seat tube for movement along a second longitudinal axis relative to the seat tube, wherein the seat piston is configured to move along the second longitudinal axis based on a pressure of the hydraulic fluid within the seat tube;
a first spring seat fixedly coupled to the seat piston for movement with the seat piston along the second longitudinal axis;
a second spring seat spaced apart from the first spring seat, wherein the second spring seat is fixedly coupled to one of the piston rod, the damper tube, and the sprung portion of the vehicle; and
a spring engaged with the first spring seat and the second spring seat, wherein the spring is configured to compress or extend based on a relative movement between the first spring seat and the second spring seat.

2. The shock absorber of claim 1, wherein the seat tube is at least partially disposed around and fixedly coupled to the damper tube, wherein each of the seat piston and the first spring seat is slidably mounted around the damper tube, and wherein the second spring seat is fixedly coupled to the piston rod.

3. The shock absorber of claim 2, further comprising a base valve fluidly disposed between the valving piston chamber and the seat piston chamber, wherein the base valve is configured to control fluid flow between the valving piston chamber and the seat piston chamber.

4. The shock absorber of claim 2, wherein the damper tube comprises one or more openings fluidly communicating the valving piston chamber with the seat piston chamber.

5. The shock absorber of claim 1, wherein the seat tube is fixedly coupled to the piston rod and spaced apart from the damper tube, wherein the piston rod further comprises a rod passage extending at least partially along a length of the piston rod and fluidly communicating the valving piston chamber with the seat piston chamber, wherein each of the seat piston and the first spring seat is slidably mounted around the piston rod, and wherein the second spring seat is fixedly coupled to the damper tube.

6. The shock absorber of claim 5, further comprising a reserve tube at least partially disposed around the damper tube and a base valve fluidly disposed between the valving piston chamber and the reserve tube, wherein the base valve is configured to control fluid flow between the valving piston chamber and the reserve tube.

7. The shock absorber of claim 1, further comprising a fluid conduit extending from the damper tube and fluidly communicating the valving piston chamber with the seat piston chamber, such that each of the seat tube, the first spring seat, and the second spring seat is remote from the damper tube, wherein the second spring seat is fixedly coupled to the sprung portion of the vehicle.

8. The shock absorber of claim 7, further comprising a reserve tube at least partially disposed around the damper tube and a base valve fluidly disposed between the valving piston chamber and the reserve tube, wherein the base valve is configured to control fluid flow between the valving piston chamber and the reserve tube, and wherein the fluid conduit is disposed in fluid communication with the reserve tube and the seat piston chamber.

9. The shock absorber of claim 1, further comprising an accumulator disposed in fluid communication with the seat tube.

10. The shock absorber of claim 1, further comprising a pump disposed in fluid communication with the seat tube.

11. The shock absorber of claim 1, wherein the second longitudinal axis is substantially aligned with or parallelly offset from the first longitudinal axis.

12. The shock absorber of claim 1, further comprising a jounce bumper mounted around the piston rod and spaced apart from the damper tube, and a bumper seat slidably mounted around the piston rod and fixedly coupled to at least one of the seat piston and the first spring seat for movement with the seat piston along the second longitudinal axis, wherein the bumper seat is configured to selectively engage with the jounce bumper in response to a relative movement of the seat piston and the jounce bumper towards each other.

13. The shock absorber of claim 12, further comprising a bumper sleeve configured to fixedly couple the bumper seat to at least one of the seat piston and the first spring seat, wherein the bumper sleeve is slidably mounted at least partially around the damper tube and axially disposed between the first spring seat and the bumper seat.

14. The shock absorber of claim 1, further comprising a first mount coupled to the sprung portion of the vehicle and a second mount coupled to the unsprung portion of the vehicle, wherein the piston rod is coupled to one of the first mount and the second mount, and wherein the damper tube is coupled to the other one of the first mount and the second mount.

15. A shock absorber for use with a sprung portion and an unsprung portion of a vehicle, the shock absorber comprising:
a damper tube defining a valving piston chamber containing a hydraulic fluid;
a piston rod extending within the damper tube along a first longitudinal axis;
a valving piston assembly slidably fitted in the damper tube for movement along the first longitudinal axis relative to the damper tube, wherein the valving piston assembly is coupled to the piston rod;
a seat tube disposed in fluid communication with the valving piston chamber and configured to receive the hydraulic fluid from the valving piston chamber, the seat tube defining a seat piston chamber therein;
a seat piston slidably fitted at least partially in the seat tube for movement along a second longitudinal axis relative to the seat tube, wherein the seat piston is configured to move along the second longitudinal axis based on a pressure of the hydraulic fluid within the seat tube;
a bumper seat fixedly coupled to the seat piston for movement with the seat piston along the second longitudinal axis; and
a jounce bumper fixedly coupled to one of the piston rod and the bumper seat.

16. The shock absorber of claim 15, wherein the seat tube is at least partially disposed around and fixedly coupled to the damper tube, wherein the seat piston is slidably mounted at least partially around the damper tube, wherein the bumper seat is slidably mounted around the piston rod, and wherein the jounce bumper is disposed around and fixedly coupled to the piston rod.

17. The shock absorber of claim 16, further comprising a base valve fluidly disposed between the valving piston chamber and the seat piston chamber, wherein the base valve is configured to control fluid flow between the valving piston chamber and the seat piston chamber.

18. The shock absorber of claim 16, wherein the damper tube comprises one or more openings fluidly communicating the valving piston chamber with the seat piston chamber.

19. The shock absorber of claim 15, wherein the seat tube is fixedly coupled to the piston rod and spaced apart from the damper tube, wherein the piston rod further comprises a rod passage extending at least partially along a length of the piston rod and fluidly communicating the valving piston chamber with the seat piston chamber, wherein each of the seat piston and the bumper seat is slidably mounted around the piston rod, and wherein the jounce bumper is disposed around and fixedly coupled to the piston rod.

20. The shock absorber of claim 15, further comprising a fluid conduit extending from the damper tube and fluidly communicating the valving piston chamber with the seat piston chamber, such that each of the seat tube, the bumper seat, and the jounce bumper is remote from the damper tube, wherein the jounce bumper is fixedly coupled to the bumper seat, and wherein the jounce bumper is configured to selectively engage with a striker member fixedly coupled to the sprung portion of the vehicle in response to a relative movement of the striker member and the jounce bumper towards each other along the second longitudinal axis.
